(19) United States
(12) Patent Application Publication
(10) Pub. No.: US 2020/0357382 A1
(43) Pub. Date: Nov. 12, 2020

(54) ORAL, FACIAL AND GESTURE COMMUNICATION DEVICES AND COMPUTING ARCHITECTURE FOR INTERACTING WITH DIGITAL MEDIA CONTENT

(71) Applicant: FACET LABS, LLC, LOS GATOS, CA (US)

(72) Inventors: STUART OGAWA, LOS GATOS, CA (US); LINDSAY ALEXANDER SPARKS, SEATTLE, WA (US); KOICHI NISHIMURA, SAN JOSE, CA (US); WILFRED P. SO, MISSISSAUGA, ON (CA)

(21) Appl. No.: 16/314,721

(22) PCT Filed: Aug. 10, 2018
(86) PCT No.: PCT/US2018/046265

§ 371 Date: Jan. 2, 2019

Related U.S. Application Data
(60) Provisional application No. 62/543,784, filed on Aug. 10, 2017.

(51) Int. Cl. G10L 13/08; G06F 9/48; G06N 20/00; G06N 5/04; G10L 15/30; G10L 13/047; G10L 13/033; G10L 15/22; H04L 12/58

(52) U.S. Cl. CPC G10L 13/08; G06F 9/4843; G06N 20/00; G06N 5/043; G06Q 50/01; G10L 13/047; G10L 13/0335; G10L 15/22; H04L 51/02; G10L 15/30

(57) ABSTRACT

The display of digital media content includes graphical user interfaces and predefined data fields that limit interaction between a person and a computing system. An oral communication device and a data enablement platform are provided for ingesting oral conversational data from people, and using machine learning to provide intelligence. At the front end, an oral conversational bot, or chatbot, interacts with a user. The chatbot is specific to a customized digital magazine, which both evolve over time to a user for a given topic. On the backend, the data enablement platform has a computing architecture that ingests data from various external data sources as well as data from internal applications and databases. These data and algorithms are applied to surface new data, identify trends, provide recommendations, infer new understanding, predict actions and events, and automatically act on this computed information. The chatbot then reads out the content to the user.

### CROSS-REFERENCE TO RELATED APPLICATION

This patent application claims priority to U.S. Provisional Patent Application No. 62/543,784, filed on Aug. 10, 2017, and titled “Oral Communication Device and Computing Architecture For Interacting with Digital Media Content”, the entire contents of which are hereby incorporated by reference.

### TECHNICAL FIELD

In one aspect, the following generally relates to an oral communication device and related computing architectures and methods for processing data and outputting digital media content, such as via audio or visual media, or both. In another aspect, the following generally relates to computing architectures and machine intelligence to ingest large volumes of data from many different data sources, and to output digital media content.

### DESCRIPTION OF THE RELATED ART

The growing popularity of user devices, such as laptops, tablets, smart phones, etc., has led to many traditional media producers to publish digital media. Digital media includes digital text, video and audio data. For example, the magazine producer called the Economist has their own website or digital magazine application (e.g. also called “app”). The newspaper producer called The New York Times has their own website or app. The television channel called the History Channel has their own website or app. Similarly, a radio channel may also have their own website or app.

For a given media producer, they will typically have their own computing infrastructure and applications, on which they store their digital media content and user to publish their content to readers, viewers, or listeners. In a typical operation, journalists, artists, radio hosts, etc. upload their digital media content to a server system, and the server system is accessed by users on their user devices to read, watch or listen to the content. Users can add comments based on the content. Users can also share the content via social data networks. In other words, a typical media producer's own computing infrastructure and software is typically suitable for their own purposes.

However, it is herein recognized that these computing architectures and software programs are not suitable for ingesting the growing velocity, volume and variety of data. In particular, the proliferation of different types of electronic devices (e.g. machine-to-machine communication, user-oriented devices, Internet of Things devices, etc.) has increased the volume and the variety of data to be analyzed and processed.

Furthermore, users typically interact with their user devices to study the data using a keyboard and a mouse or trackpad, along with a display device (e.g. a computer monitor). Touchscreen devices with touchscreen graphical user interfaces (GUIs) have made user interaction more similar to using a conventional paper newspaper or magazine. However, it is herein recognized that these types of computing device interactions are still complex, difficult and time consuming for a user. Furthermore, the input interfaces in the GUIs (e.g. comment fields, search fields, pointer or cursor interface, etc.) are typically predetermined by design and, therefore, limit the type of data being inputted.

It is herein recognized that these, and other technical challenges, limit the variety and relevancy of the data being presented to the user, as well as limit interaction between the computing system and the user.

### BRIEF DESCRIPTION OF THE DRAWINGS

Embodiments will now be described by way of example only with reference to the appended drawings wherein:

FIG. 1 is a schematic diagram of an example computing architecture for ingesting user data via user devices, and providing big data computations and machine learning using a data enablement platform.

FIG. 2 is another schematic diagram, show another representation of the computing architecture in FIG. 1.

FIG. 3 is a schematic diagram of oral communication devices (OCDs) in communication with respective user devices, which are in turn in communication with the data enablement platform.

FIG. 4A is a schematic diagram showing an OCD being used in a meeting and showing the data connections between various devices and the data enablement platform.

FIG. 4B is a schematic diagram showing different embodiments of an OCD, including wearable devices, and an OCD embodiment configured to provide augmented reality or virtual reality.

FIG. 5 is a block diagram showing example components of the OCD.

FIG. 6 is a schematic diagram showing an example computing architecture for an artificial intelligence (AI) platform, which is part of the data enablement platform.

FIG. 7 is a schematic diagram showing another example aspect of the computing architecture for the AI platform.

FIG. 8 is a schematic diagram showing an example computing architecture for an extreme data platform, which is an example aspect of the AI platform.

FIG. 9 is a flow diagram of executable instructions for processing voice data using a user device and further processing the data using the data enablement platform.

FIG. 10 is a block diagram of example software modules residing on the user device and the data enablement platform, which are used in the digital media industry.

FIG. 11 is an example schematic diagram showing the flow of data between some of the software modules shown in FIG. 10.

FIGS. 12 and 13 are screenshots of example graphical user interfaces (GUIs) of a digital magazine displayed on a user device.

FIG. 14 is a flow diagram of example executable instructions for using the data enablement platform to monitor a given topic.

FIG. 15 is a flow diagram of example executable instructions for using the data enablement platform to monitor a given topic, including using both internal and external data.

FIG. 16 is a flow diagram of example executable instructions for using the data enablement platform to identify one or more users that have a similar user profile as a subject user.

FIG. 17 is a flow diagram of example executable instructions for using the data enablement platform to modify the audio parameters of certain phrases and sentences.

FIG. 18 is a flow diagram of example executable instructions for using the data enablement platform to extract data features from voice data and associated background noise.

FIG. 19 is an example embodiment of a Digital Signal Processing (DSP)-based voice synthesizer.

FIG. 20 is an example embodiment of a hardware system used by the DSP-based voice synthesizer.

FIG. 21 is a flow diagram of example executable instructions for building a voice library of a given person.

FIG. 22 is a flow diagram of example executable instructions for a user device interacting with a user.

FIG. 23 is a flow diagram of example executable instructions for a user device interacting with a user.

FIG. 24 is a flow diagram of example executable instructions for a user device interacting with a user.

FIG. 25 is a flow diagram of example executable instructions for a user device interacting with a user, which continues from the flow diagram in FIG. 24.

FIG. 26 is a flow diagram of example executable instructions for a user device interacting with a user in relation to a given topic and using a synthesized voice of a given person.

FIG. 27 is a flow diagram of example executable instructions for a user device reading out a digital article using a synthesized voice of a given person.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It is herein recognized that typical computing architectures and software programs, such as for digital media publications, are limited to ingest limited types of data and usually from a small number of data sources. These types of data are based on internal databases. However, it is herein recognized that there are many more types of data, and from different data sources, that can be used and processed to provide interesting data to a person. For example, it is recognized that data sources can include, but are not limited to, any one or more of: data from Internet of Things (IoT) devices, various newspaper servers, various television channels, various radio networks, various magazine servers, social data networks and related platforms, internal databases, data obtained via individual user devices, stock exchange platforms, blogs, third-party search engines, etc. From these example sources, it is appreciated that the types of data are varied and that the data can be constantly updating.

It is appreciated that there are apps or websites that collect digital media content so that users can centrally browse through many different publications. For example, there are re-publishing websites that allow a user to browse through different digital magazines (e.g. the Economist, Times, Chatelaine, Forbes, Wired, etc.). However, a user may need to review a magazine issue to find an article of interest. In some cases, a user can conduct a topic search, but this typically leads to different links, which when activated, open up different digital magazines. This type of content segmentation and interaction also occurs for re-publishing websites that re-publish newspaper articles. It is therefore recognized that the organization of the digital media content is disjointed and creates additional user interaction steps at the GUI.

Furthermore, it is herein recognized that in many digital media computing systems, the data inputs include predefined fields. A person typically uses a keyboard or a touchscreen device to input text into the predefined fields of a GUI. These predefined input fields and input GUIs are processed using more typical computing software. It is herein recognized that such an approach inherently ignores utilizing the variety and the volume of data that is available for various data sources, which likely have data types and data formats that do not conform to the predefined input forms and input GUIs.

It is herein recognized that people often think, talk and act in non-predefined patterns. In other words, the thought process or a conversation between people does not typically follow predefined GUIs and predefined input forms. Using existing GUIs, a person will need to extract their notes from a conversation and input the extracted portions of information into the predefined GUIs and input forms. This process is even more burdensome and complex when many people have a meeting, and a person must identify the relevant information to type into a predefined GUI or predefined input forms. Not only is this data entry process inefficient, but the technology inherently ignores other data from the individual's thoughts, or the conversations, or the meetings, or combinations thereof.

It is also herein recognized that publishers and content producers spend a lot of time attempting to understand, analyze and predict what a consumer is interested in reading and seeing. Despite systems from FaceBook, Google, Amazon, YouTube, CNN, to name a few, these systems are predominantly machine learned content generation systems that present content that is limited in breadth and depth. This becomes a limiting factor for consumers who are enthusiasts, hobbyists, and connoisseurs of a topic or interest. For example, if a hobbyist is interested in building and evaluating stereo tube amplifiers or techniques for welding aluminum, the enthusiast rarely, spends times on FaceBook, Google, YouTube, etc. The enthusiast may search for links to sites, which have enthusiast content such as publications, industry news, blogs, and forums. Even if the enthusiast finds these specialty sites, the amount of content that continues to get produced and published is overwhelming and the enthusiast has to search and review what the latest real time information that has specific content that is relevant and interesting to him or her.

It is herein recognized that it is desirable to provide a systems and methods to help consumer enthusiasts to capture and read enthusiast information that is real time, that autonomously and intelligently captures deep enthusiast information, and that is easy to consume.

Therefore, one or more user devices, computing architecture and computing functionality are described herein to address one or more of the above technical challenges.

In an example embodiment, an oral communication user device (e.g. a device that includes a microphone) records oral information from a user (e.g. the user's word and sounds) to interact with a data enablement system. The data enablement system processes the voice data to extract, at least the words and of the spoken language, and accordingly processes the data using artificial intelligence computing software and data science algorithms. The data obtained from the oral communication device is processed in combination with, or comparison with, or both, internal data specific to an organization (e.g. a given digital media company) and external data (e.g. available from data sources outside a given digital media company). The computing architecture ingests data from external data sources and internal data sources to provide real-time outputs or near real-time data outputs, or both. The data outputs are presented to the user as audio feedback, or visual feedback, or both. Other types of user feedback may be used, including tactile feedback. Other machine actions may be initiated or executed based on the data outputs.

In another example embodiment, the oral communication device is a wearable technology that tracks a user's movement. Currently known and future known wearable devices are applicable to the principles described herein. In another example embodiment, the oral communication device is part of a virtual reality system or augmented reality system, or both. In other words, the display of visual data is immersive and the user can interact with the visual data using oral statements and questions, or using physical movement, or using facial expressions, or a combination thereof.

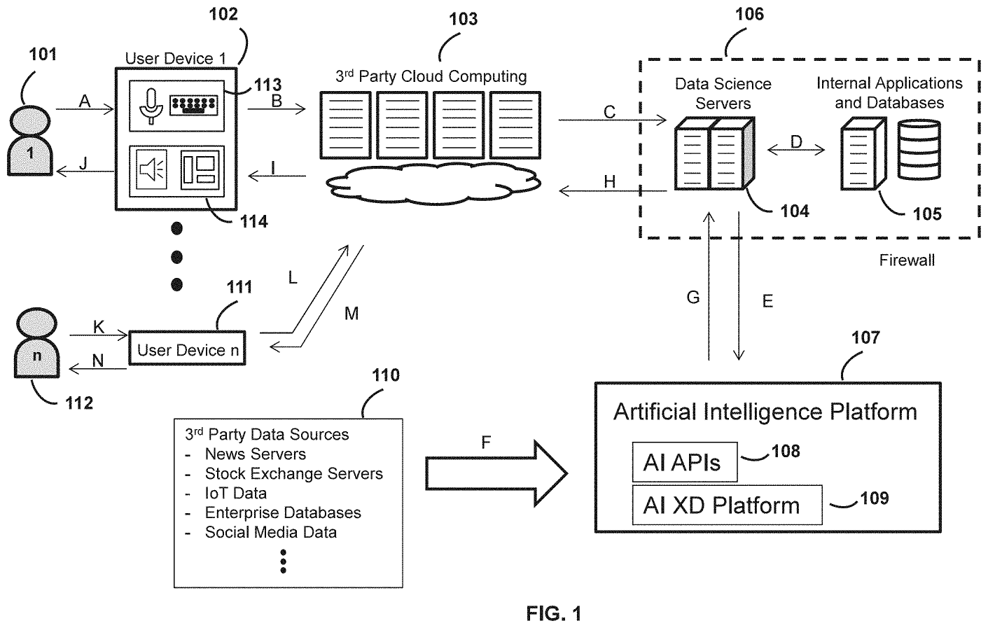

Turning to FIG. 1, a user device 102 interacts with a user 101. The user device 102 includes, amongst other things, input devices 113 and output devices 114. The input devices include, for example, a microphone and keyboard (e.g. physical keyboard or touchscreen keyboard, or both). The output devices include, for example, an audio speaker and a display screen. Non-limiting examples of user devices include a mobile phone, a smart phone, a tablet, smart watches, headsets that provide augmented reality or virtual reality or both, a desktop computer, a laptop, an e-book, and an in-car computer interface. The user device is in communication with a 3^{rd} party cloud computing service 103, which typically includes banks of server machines. Multiple user devices 111, which correspond to multiple users 112, can communicate with the 3^{rd} part cloud computing service 103.

The cloud computing service 103 is in data communication with one or more data science server machines 104. These one or more data science server machines are in communication with internal application and databases 105, which can reside on separate server machines, or, in another example embodiment, on the data science server machines. In an example embodiment, the data science computations executed by the data science servers and the internal applications and the internal databases are considered proprietary to given organization or company, and therefore are protected by a firewall 106. Currently known firewall hardware and software systems, as well as future known firewall systems can be used.

The data science server machines, also called data science servers, 104 are in communication with an artificial intelligence (AI) platform 107. The AI platform 107 includes one or more AI application programming interfaces (APIs) 108 and an AI extreme data (XD) platform 109. As will be discussed later, the AI platform runs different types of machine learning algorithms suited for different functions, and these algorithms can be utilized and accessed by the data science servers 104 via an AI API.

The AI platform also is connected to various data sources 110, which may be 3^{rd} party data sources or internal data sources, or both. Non-limiting examples of these various data sources include: news servers, radio networks, television channel networks, magazine servers, stock exchange servers, IoT data, enterprise databases, social media data, etc. In an example embodiment, the AI XD platform 109 ingests and processes the different types of data from the various data sources.

In an example embodiment, the network of the servers 103, 104, 105, 107 and optionally 110 make up a data enablement system. The data enablement system provides relevant to data to the user devices, amongst other things. In an example embodiment, all of the servers 103, 104, 105 and 107 reside on cloud servers.

An example of operations is provided with respect to FIG. 1, using the alphabetic references. At operation A, the user device 102 receives input from the user 101. For example, the user is speaking and the user device records the audio data (e.g. voice data) from the user. The user could be recording or memorializing thoughts to himself or herself, or providing himself or herself a to-do list to complete in the future, or providing a command or a query to the data enablement system. In an example embodiment, a data enablement application is activated on the user device and this application is placed into a certain mode, either by the user or autonomously according to certain conditions.

At operation B, the user device transmits the recorded audio data to the 3^{rd} party cloud computing servers 103. In an example embodiment, the user device also transmits other data to the servers 103, such as contextual data (e.g. time that the message was recorded, information about the user, the mode of the data enablement application during which the message was recorded, etc.) These servers 103 apply machine intelligence, including artificial intelligence, to extract data features from the audio data. These data features include, amongst other things: text, sentiment, emotion, background noise, a command or query, or metadata regarding the storage or usage, or both, of the recorded data, or combinations thereof.

At operation C, the servers 103 send the extracted data features and the contextual data to the data science servers 104. In an example embodiment, the servers 103 also send the original recorded audio data to the data science servers 104 for additional processing.

At operation D, the data science servers 104 interact with the internal applications and databases 105 to process the received data. In particular, the data science servers store and executed one or more various data science algorithms to process the received data (from operation C), which may include processing proprietary data and algorithms obtained from the internal applications and the databases 105.

In alternative, or in addition to operation D, the data science servers 104 interact with the AI platform 107 at operations E and G. In an example embodiment, the data science servers 104 have algorithms that process the received data, and these algorithms transmit information to the AI platform for processing (e.g. operation E). The information transmitted to the AI platform can include: a portion or all of the data received by the data science servers at operation C; data obtained from internal applications and databases at operation D; results obtained by the data science servers from processing the received data at operation C, or processing the received data at operation D, or both; or a combination thereof. In turn, the AI platform 107 processes the data received at operation E, which includes processing the information ingested from various data sources 110 at operation F. Subsequently, the AI platform 107 returns the results of its AI processing to the data science servers in operation G.

Based on the results received by the data science servers 104 at operation G, the data science servers 104, for example, updates its internal applications and databases 105 (operation D) or its own memory and data science algorithms, or both. The data science servers 104 also provide an output of information to the 3^{rd} party cloud computing servers 104 at operation H. This outputted information may be a direct reply to a query initiated by the user at operation A. In another example, either in alternative or in addition, this outputted information may include ancillary information that is either intentionally or unintentionally requested based on the received audio information at operation A. In another example, either in alternative or in addition, this outputted information includes one or more commands that are either intentionally or unintentionally initiated by received audio information at operation A. These one or more commands, for example, affect the operation or the function of the user device 102, or other user devices 111, or IoT devices in communication with the 3^{rd} party cloud computing servers 104, or a combination thereof.

The 3^{rd} party cloud computing servers 104, for example, takes the data received at operation H and applies transformation to the data, so that the transformed data is suitable for output at the user device 102. For example, the servers 104 receive text data at operation H, and then the servers 104 transform the text data to spoken audio data. This spoken audio data is transmitted to the user device 102 at operation I, and the user device 102 then plays or outputs the audio data to the user at operation J.

This process is repeated for various other users 112 and their user devices 111. For example, another user speaks into another user device at operation K, and this audio data is passed into the data enablement platform at operation L. The audio data is processed, and audio response data is received by the another user device at operation M. This audio response data is played or outputted by the another user device at operation N.

In another example embodiment, the user uses touchscreen gestures, movements, typing, etc. to provide inputs into the user device 102 at operation A, either in addition or in alternative to the oral input. In another example embodiment, the user device 102 provides visual information (e.g. text, video, pictures) either in addition or in alternative to the audio feedback at operation J.

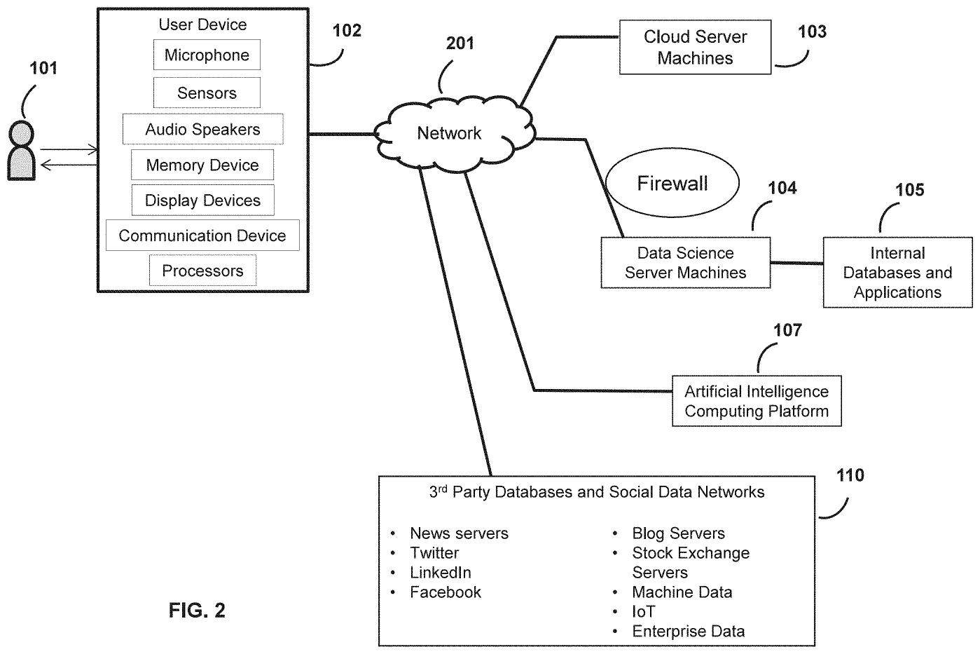

Turning to FIG. 2, another example of the servers and the devices are shown in a different data networking configuration. The user device 102, the cloud computing servers 103, the data science servers 104, AI computing platform 107, and the various data sources 110 are able to transmit and receive data via a network 201, such as the Internet. In an example embodiment, the data science servers 104 and the internal applications and databases 105 are in communication with each other over a private network for enhanced data security. In another example embodiment, the servers 104 and the internal applications and the databases 105 are in communication with each other over the same network 201.

As shown in FIG. 2, example components of the user device 102 include a microphone, one or more other sensors, audio speakers, a memory device, one or more display devices, a communication device, and one or more processors. The user device can also include a global positioning system module to track the user device's location coordinates. This location information can be used to provide contextual data when the user is consuming digital media content, or interacting with the digital media content (e.g. adding notes, swipe gestures, eye-gaze gestures, voice data, adding images, adding links, sharing content, etc.), or both.

In an example embodiment, the user device's memory includes various “bots” that are part of the data enable application, which can also reside on the user device. In an example aspect, the one or more bots are considered chatbots or electronic agents. These bots include processing that also resides on the 3^{rd} party cloud computing servers 103. Examples of chat bot technologies that can be adapted to the system described herein include, but are not limited to, the trade names Siri, Google Assistant, and Cortana. In an example aspect, the bot used herein has various language dictionaries that are focused on various enthusiast topics and general interest topics. In an example aspect, the bot used herein is configured to understand questions and answers specific to various enthusiast topics and general interest topics.

In an example aspect, the bot used herein learns the unique voice of the user, which the bot consequently uses to learn behavior that may be specific to the user. This anticipated behavior in turn is used by the data enablement system to anticipate future questions and answers related to a given topic. This identified behavior is also used, for example, to make action recommendations to help the user achieve a result, and these action recommendations are based on the identified behaviors (e.g. identified via machine learning) of higher ranked users having the same topic interest. For example, users can be ranked based on their expertise on a topic, their influence on a topic, their depth of commentary (e.g. private commentary or public commentary, or both) on a topic, the complexity of their chatbot for a given topic, etc.

In an example aspect, the bot applies machine learning to identify unique data features in the user voice. Machine learning can include, deep learning. Currently known and future known algorithms for extracting voice features are applicable to the principles described herein. Non-limiting examples of voice data features include one or more of: tone, frequency (e.g. also called timbre), loudness, rate at which a word or phrase is said (e.g. also called tempo), phonetic pronunciation, lexicon (e.g. choice of words), syntax (e.g. choice of sentence structure), articulation (e.g. clarity of pronounciation), rhythm (e.g. patterns of long and short syllables), and melody (e.g. ups and downs in voice). As noted above, these data features can be used identify behaviors and meanings of the user, and to predict the content, behavior and meaning of the user in the future. It will be appreciated that prediction operations in machine learning include computing data values that represent certain predicted features (e.g. related to content, behavior, meaning, action, etc.) with corresponding likelihood values.

The user device may additional or alternatively receive video data or image data, or both, from the user, and transmit this data via a bot to the data enablement platform. The data enablement platform is therefore configured to apply different types of machine learning to extract data features from different types of received data. For example, the 3^{rd} party cloud computing servers use natural language processing (NLP) algorithms or deep neural networks, or both, to process voice and text data. In another example, the 3^{rd} party cloud computing servers use machine vision, or deep neural networks, or both, to process video and image data.

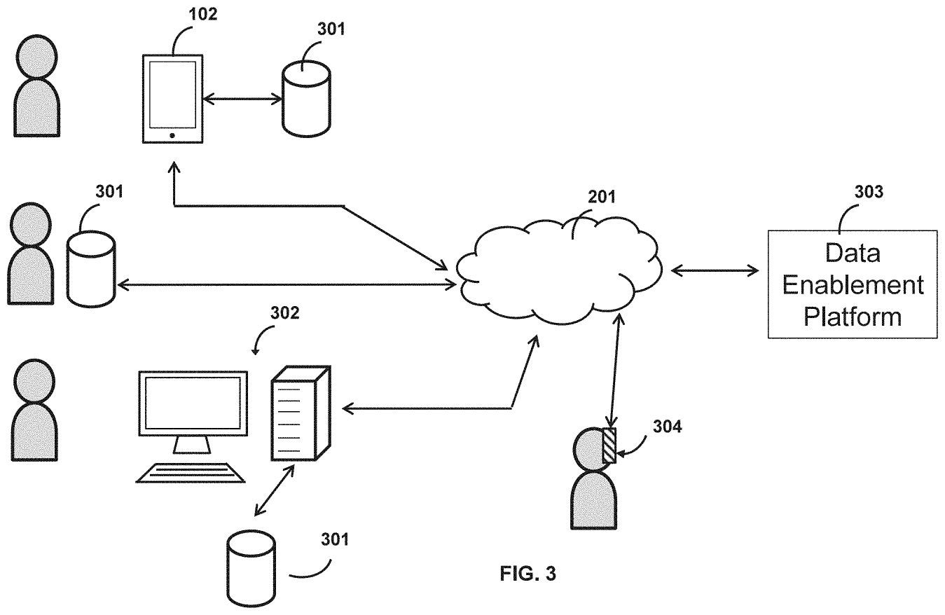

Turning to FIG. 3, an example embodiment of an oral communication device (OCD) 301 is shown, which operates in combination with the user device 102 to reduce the amount of computing resources (e.g. hardware and processing resources) that are consumed by the user device 102 to execute the data enablement functions, as described herein. In some cases, the OCD 301 provides better or additional sensors than a user device 102. In some cases, the OCD 301 is equipped with better or additional output devices compared to the user device 102. For example, the OCD includes one or more microphones, one or more cameras, one or more audio speakers, and one or more multimedia projects which can project light onto a surface. The OCD also includes processing devices and memory that can process the sensed data (e.g. voice data, video data, etc.) and process data that has been outputted by the data enablement platform 303. As noted above, the data enablement platform 303 includes, for example, the servers 103, 104, 105, and 107.

As shown in FIG. 3, the OCD 301 is in data communication with the user device via a wireless or wired data link. In an example embodiment, the user device 102 and the OCD 301 are in data communication using a Bluetooth protocol. The user device 102 is in data communication with the network 201, which is in turn in communication with the data enablement platform 303. In operation, when a user speaks or takes video, the OCD 301 records the audio data or visual data, or both. The OCD 301, for example, also pre-processes the recorded data, for example, to extract data features. The pre-processing of the recorded data may include, either in addition or in the alternative, data compression. This processed data or the original data, or both, are transmitted to the user device 102, and the user device transmits this data to the data enablement platform 303, via the network 201. The user device 102 may also transmit contextual data along with the data obtained or produced by the OCD 301. This contextual data can be generated by the data enablement application running on the user device 102, or by the OCD 301.

Outputs from the data enablement platform 303 are sent to the user device 102, which then may or may not transmit the outputs to the OCD 301. For example, certain visual data can be displayed directly on the display screen of the user device 102. In another example embodiment, the OCD receives the inputs from the user device and provides the user feedback (e.g. plays audio data via the speakers, displays visual data via built-in display screens or built-in media projectors, etc.).

In an example embodiment, the OCD 301 is in data connection with the user device 102, and the OCT 301 itself has a direct connection to the network 201 to communicate with the data enablement platform 303.

Similar functionality is applicable to the other instance of the OCD 301 that is in data communication with the desktop computer 302. In particular, it is herein recognized that many existing computing devices and user devices are not equipped with sensors of sufficient quality, nor with processing hardware equipped to efficiently and effectively extract the features from the sensed data. Therefore, the OCD 301 supplements and augments the hardware and processing capabilities of these computing devices and user devices.

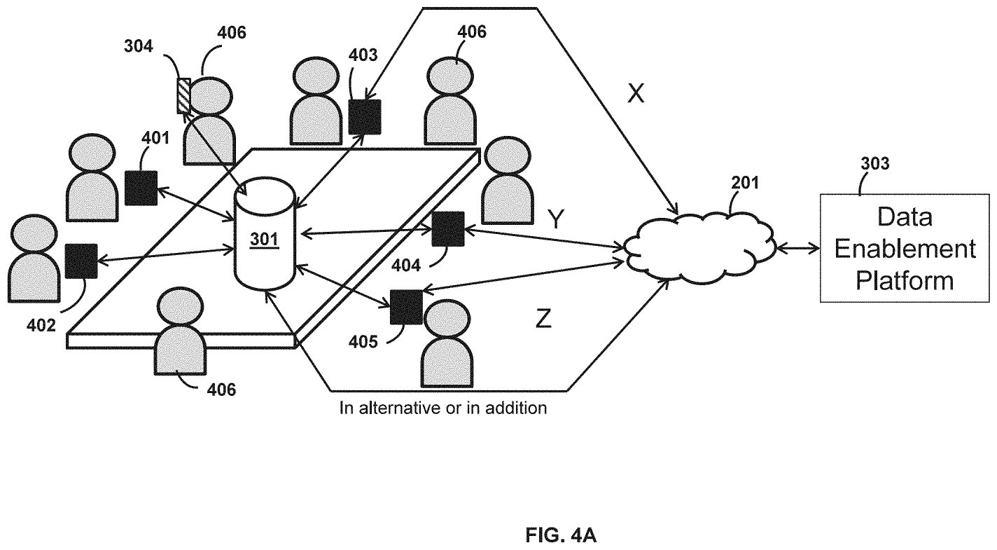

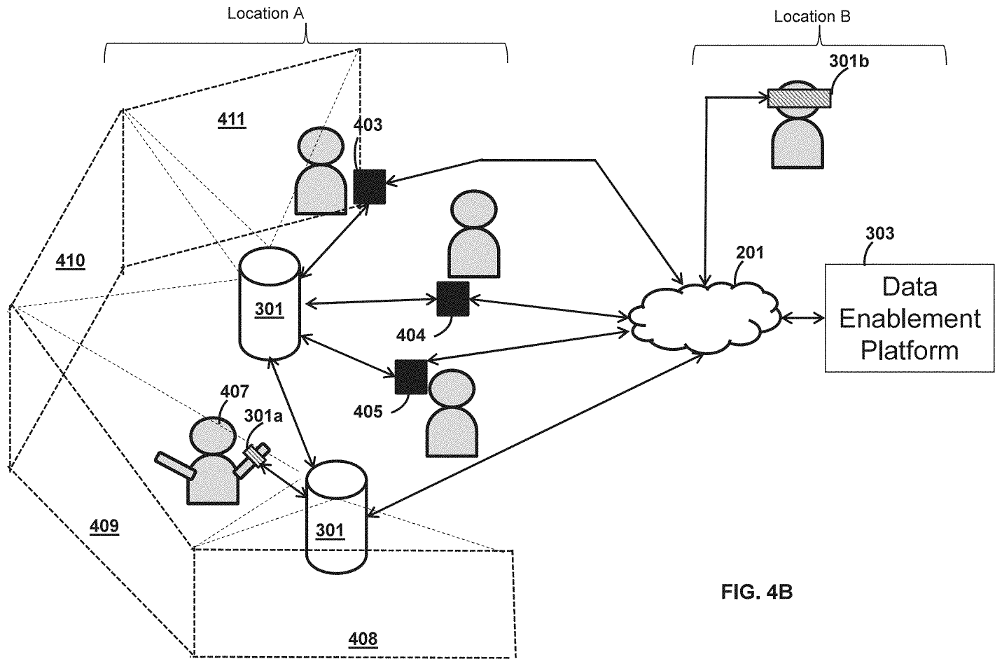

In an example embodiment, a different example of a silent OCD 304 is used to record the language inputs of the user. The silent OCD 304 includes sensors that detects other user inputs, but which are not the voice. Examples of sensors in the silent OCD 304 include one or more of: brain signal sensors, nerve signal sensors, and muscle signal sensors. These sensors detect silent gestures, thoughts, micro movements, etc., which are translated to language (e.g. text data). In an example embodiment, these sensors include electrodes that touch parts of the face or head of the user. In other words, the user can provide language inputs without having to speaking into a microphone. The silent OCD 304, for example, is a wearable device that is worn on the head of the user. The silent OCD 304 is also sometimes called a silent speech interface or a brain computer interface. The silent OCD 304, for example, allows a user to interact with their device in a private manner while in a group setting (see FIG. 4A) or in public.

Turning to FIG. 4A, the OCD 301 is shown being used in a meeting with various people, each having their own respective user devices. 401, 402, 403, 404, 405, 304. The OCD can also be used to record data (e.g. audio data, visual data, etc.) and provide data to people that do not have their own user device. The OCD records the oral conversation of the meeting to, for example, take meeting notes. In another aspect, the OCD also links to the user devices to give them information, for example, in real-time about the topics being discussed during the meeting. The OCD also reduces the computing resources (e.g. hardware and processing resources) on the individual user devices.

In an example embodiment, the user 406 wears a silent OCD 304 to privately interact using with the OCD 301. For example, the user's brain signals, nerve signals, muscle signals, or a combination thereof, are captured are synthesized into speech. In this way, the user 406 can at times give private or silent notes, commands, queries, etc. to the OCD 301, and at other times, provide public notes, commands, queries, etc. to the OCD 301 that are heard by the other users in the meeting.

In an example embodiment, the user devices 401, 402, 403, 404, 405, 304 are in data communication with the OCD 301 via a wireless connection, or a wired connection. In an example embodiment, some of the user devices 401, 402 do not have Internet access, but other user devices 403, 404, 405 do have Internet access over separate data connections X, Y and Z. Therefore, the OCD 301 uses one or more of these data connections X, Y and Z to transmit and receive data from the data enablement platform 303.

The OCD may use different communication routes based on the available bandwidth, which may be dictated by the user devices.

For example, the OCD parses a set of data to be transmitted to the data enablement platform into three separate data threads, and transmits these threads respectively to the user devices 403, 404 and 405. In turn, these data threads are transmitted by the user devices over the respective data connections X, Y and Z to the data enablement platform 303, which reconstitute the data from the separate threads into the original set of data.

Alternatively, the OCD uses just one of the data connections (e.g. X) and therefore funnels the data through the user device 403.

In another example embodiment, the OCD designates the data connections X and Y, corresponding to the user deices 403 and 404, for transmitting data to the data enablement platform 303. The OCD designates the data connection Z, corresponding to the user device 405, for receiving data from the data enablement platform 303.

The data obtained by the OCD, either originating from a user device or the data enablement platform, can be distributed amongst the user devices that are in communication with the OCD. The OCD can also provide central user feedback (e.g. audio data, visual data, etc.) to the users in the immediate vicinity.

It will be appreciated that the OCD therefore acts as a local central input and output device. In another example aspect, the OCD also acts as a local central processing device to process the sensed data, or processed the data from the data enablement platform, or both. In another example aspect, OCD also acts as a local central communication hub.

In an example embodiment, the OCD, either in the alternative or in addition, the OCD has its own network communication device and transmits and receives data, via the network 201, with the data enablement platform 303.

The OCD provides various functions in combination with the data enablement platform 303. In an example operation, the OCD provides an audio output that orally communicates the agenda of the meeting. In an example operation, the OCD records the discussion items that are spoken during the meeting, and automatically creates text containing meeting minutes. In an example operation, the OCD monitors the flow of the discussion and the current time, and at appropriate times (e.g. after detecting one or more of: pauses, hard stops, end of sentences, etc.) the OCD interjects to provide audio feedback about moving on to the next agenda item that is listed in the agenda. A pause, for example, is a given time period of silence.

In an example operation, the OCD monitors topics and concepts being discussed and, in real-time, distributes ancillary and related data intelligence to the user devices. In an example operation, the OCD monitors topics and concepts being discussed and, in real-time, determines if pertinent related news or facts are to be shared and, if so, interjects the conversation by providing audio or visual outputs (or both) that provides the pertinent related news or facts. In an example aspect, the OCD interjects and provides the audio or visual outputs (or bot) at appropriate times, such as after detecting one or more of: a pause (e.g. a time period of silence), a hard stop, an end of a sentence, etc.

In another example operation, the OCD monitors topics and concepts being discussed and, in real-time, determines if a user provided incorrect information and, if so, interjects the conversation by providing audio or visual output that provides the correct information. For example, the determination of incorrectness is made by comparing the discussed topics in real-time with trusted data sources (e.g. newspapers, internal databases, government websites, etc.).

In another example operation, the OCD provides different feedback to different user devices, to suit the interests and goals specific the different users, during the meeting.

In another example operation, the OCD uses cameras and microphones to record data to determine the emotion and sentiment of various users, which helps to inform decision making.

In another example operation, each of the users can use their user devices in parallel to interact with the OCD or the data enablement platform, or both, to conduct their own research or make private notes (or both) during the meeting.

In another example aspect, private notes of a given user can be made using their own device (e.g. a device like the silent OCD 304 and the device 401), and public notes can be made based on the discussion recorded at threshold audible levels by the OCD 301. The private notes for example, can also be recorded orally or by silent speech using the silent OCD 304. For the given user, the data enablement platform, or their own user device, will compile and present a compilation of both the given user's private notes and public notes that are organized based on time. For example:

@t1: public notes;
@t2: public notes+given user's private notes;
@t3: public notes
@t4: given user's private notes;
@t5: public notes+given user's private notes.

In another example embodiment, the OCD includes one or more media projectors to project light images on surrounding surfaces.

It will be appreciated that while the housing body of the OCD is shown to be cylindrical, in other example embodiments, it has different shapes.

Turning to FIG. 4B, users in Location A are interacting with one or more OCDs, and a user in a separate location (i.e. Location B) is interacting with another OCD. Together, these users, although at different locations can interact with each through digital voice and imagery data. The data enablement platform processes their data inputs, which can include voice data, image data, physical gestures and physical movements. These data inputs are then used to by the data enablement platform to provide feedback to the users.

At Location A, two OCD units 301 are in data communication with each other and project light image areas 411, 410, 409, 408. These projected light image areas are positioned in a continuous fashion to provide, in effect, a single large projected light image area that can surround or arc around the users. This produces an augmented reality or virtual reality room. For example, one OCD unit projects light image areas 411 and 410, and another OCD unit projects light image areas 409 and 408.

Also at Location A is a user 407 that is wearing another embodiment of an OCD 301a. This embodiment of the OCD 301a includes a microphone, audio speakers, a processor, a communication device, and other electronic devices to track gestures and movement of the user. For example, these electronic devices include one or more of a gyroscope, an accelerometer, and a magnetometer. These types of devices are all inertial measurement units, or sensors. However, other types of gesture and movement tracking can be used. In an example embodiment, the OCD 301a is trackable using triangulation computed from radio energy signals from the two OCD units 301 positioned at different locations (but both within Location A). In another example, image tracking from cameras is used track gestures.

The users at Location A can talk and see the user at Location B.

Conversely, the user at Location B is wearing a virtual reality or augmented reality headset, which is another embodiment of an OCD 301b, and uses this to talk and see the users at Location A. The OCD embodiment 301b projects or displays images near the user's eyes, or onto the user's eyes. The OCD embodiment 301b also includes a microphone, audio speaker, processor, and communication device, amongst other electronic components. Using the OCD embodiment 301b, the user is able to see the same images being projected onto one or more of the image areas 411, 410, 409, and 408.

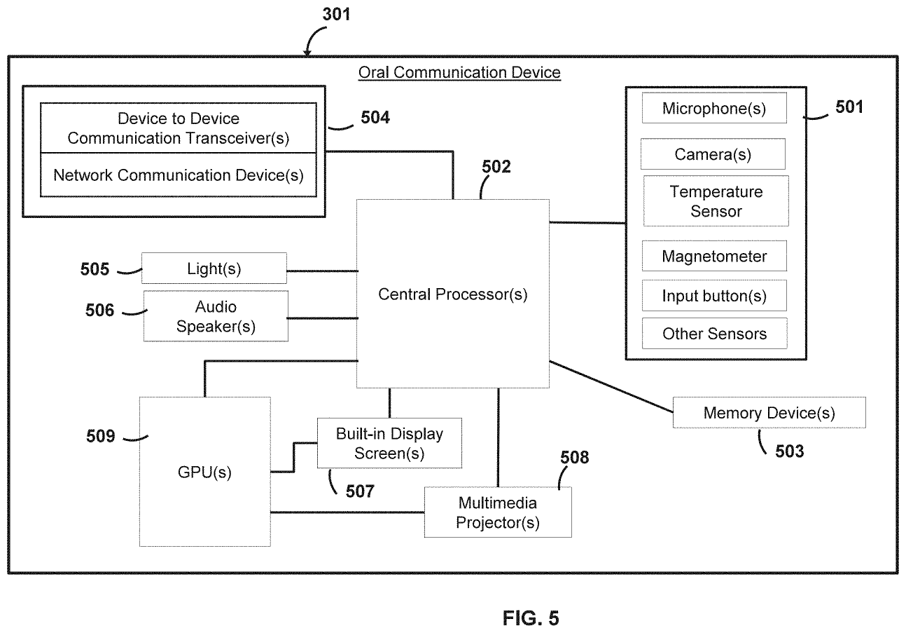

Turning to FIG. 5, example components that are housed within the OCD 301 are shown. The components include one or more central processors 502 that exchange data with various other devices, such as sensors 501. The sensors include, for example, one or more microphones, one or more cameras, a temperature sensor, a magnetometer, one or more input buttons, and other sensors.

In an example embodiment, there are multiple microphones that are oriented to face in different directions from each other. In this way, the relative direction or relative position of an audio source can be determined. In another example embodiment, there are multiple microphones that are tuned or set to record audio waves at different frequency ranges (e.g. a microphone for a first frequency range, a microphone for a second frequency range, a microphone for a third frequency range, etc.). In this way, more definition of audio data can be recorded across a larger frequency range.

In an example embodiment, there are multiple cameras that are oriented to face in different directions. In this way, the OCD can obtain a 360 degree visual field of view. In another example, one or more cameras have a first field of a view with a first resolution and one or more cameras have a second field of view with a second resolution, where the first field of view is larger than the second field of view and the first resolution is lower than the second resolution. In a further example aspect, the one or more cameras with the second field of view and the second resolution can be mechanically oriented (e.g. pitched, yawed, etc.) while the one or more cameras with the first field of view and the first resolution are fixed. In this way, video and images can be simultaneously taken from a larger perspective (e.g. the surrounding area, people's bodies and their body gestures), and higher resolution video and images can be simultaneously taken for certain areas (e.g. people faces and their facial expressions). It will be appreciated that currently known and future known image processing algorithms and facial expression data libraries that are used to process facial expressions are applicable to the principles described herein.

The OCD also includes one or more memory devices 503, lights 505, one or more audio speakers 506, one or more communication devices 504, one or more built-in-display screens 507, and one or more media projectors 508. The OCD also includes one or more graphics processing units (GPUs) 509. GPUs or other types of multi-threaded processors are configured for executing AI computations, such as neural network computations. The GPUs are also used, for example, to process graphics that are outputted by the multimedia projector(s) or the display screen(s) 507, or both.

In an example embodiment, the communication devices include one or more device-to-device communication transceivers, which can be used to communicate with one or more user devices. For example, the OCD includes a Bluetooth transceiver. In another example aspect, the communication devices include one or more network communication devices that are configured to communicate with the network 201, such as a network card or WiFi transceiver, or both.

In an example embodiment, there are multiple audio speakers 506 positioned on the OCD to face in different directions. In an example embodiment, there are multiple audio speakers that are configured to play sound at different frequency ranges.

In an example embodiment, the built-in display screen forms a curved surface around the OCD housing body. In an example embodiment, there are multiple media projectors that project light in different directions.

In an example embodiment, the OCD is able to locally pre-process voice data, video data, image data, and other data using on-board hardware and machine learning algorithms. This reduces the amount of data being transmitted to the data enablement platform 303, which reduced bandwidth consumption. This also reduces the amount of processing required by the data enablement platform.

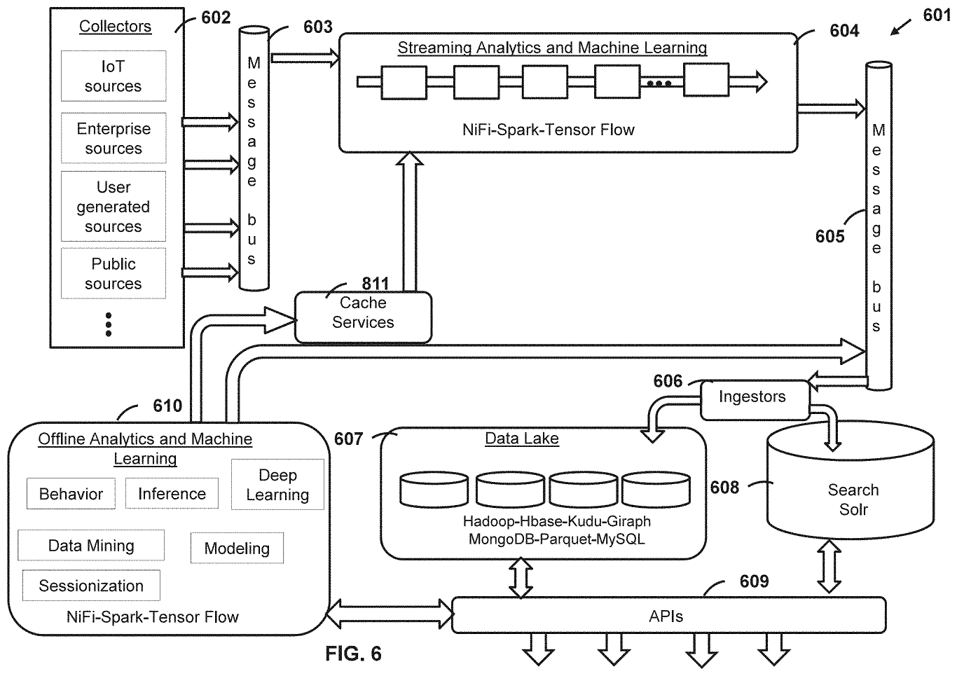

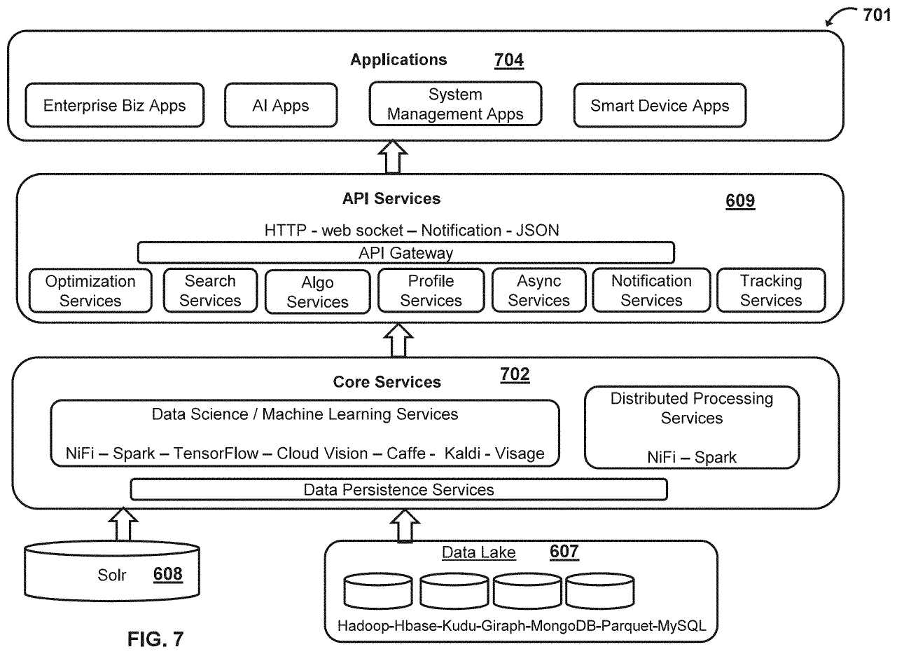

FIGS. 6 and 7 show example computing architectures of the data enablement platform, which are in alternative to the above-discussed architectures. In another example, these computing architectures shown in FIGS. 6 and 7 are incorporated into the above-discussed architectures.

Turning to FIG. 6, an example computing architecture 601 is provided for collecting data and performing machine learning on the same. This architecture 601, for example, is utilized in the AI platform 107.

The architecture 601 includes one or more data collector modules 602 that obtain data from various sources, such as news content, radio content, magazine content, television content, IoT devices, enterprise software, user generated websites and data networks, and public websites and data networks. Non-limiting examples of IoT devices include sensors used to determine the status of products (e.g. quantity of product, current state of product, location of product, etc.). IoT devices can also be used to determine the status of users (e.g. wearable devices). IoT devices can also be used to determine the state of users (e.g. wearable devices), the environment of the user, or sensors that collect data regarding a specific topic. For example, if a person is interested in weather, then IoT sensors could be weather sensors positioned around the world. If a person is interested in smart cities, then IoT sensors could include traffic sensors. Enterprise software can include CRM software so that a publication company can manage customer relations with users, publishers and content producers. User generated data includes social data networks, messaging applications, blogs, and online forums. Public websites and data networks include government websites and databases, banking organization websites and databases, economic and financial affairs websites and databases. It can be appreciated that other digital data sources may be collected by the data collector modules.

The collected data is transmitted via a message bus 603 to a streaming analytics engine 604, which applies various data transforms and machine learning algorithms. For example, the streaming analytics engine 604 has modules to transform the incoming data, apply language detection, add custom tags to the incoming data, detect trends, and extract objects and meaning from images and video. It will be appreciated that other modules may be incorporated into the engine 604. In an example implementation, the engine 604 is structured using one or more of the following big data computing approaches: NiFi, Spark and TensorFlow.

NiFi automates and manages the flow of data between systems. More particularly, it is a real-time integrated data logistics platform that manages the flow of data from any source to any location. NiFi is data source agnostic and supports different and distributes sources of different formats, schemas, protocols, speeds and sizes. In an example implementation, NiFi operates within a Java Virtual Machine architecture and includes a flow controller, NiFi extensions, a content repository, a flowfile repository, and a provenance repository.

Spark, also called Apache Spark, is a cluster computing framework for big data. One of the features of Spark is Spark Streaming, which performs streaming analytics. It ingests data in mini batches and performs resilient distributed dataset (RDD) transformations on these mini batches of data.

TensorFlow is software library for machine intelligence developed by Google. It uses neural networks which operate on multiple central processing units (CPUs), GPUs and tensor processing units (TPUs).

Offline analytics and machine learning modules 610 are also provided to ingest larger volumes of data that have been gathered over a longer period of time (e.g. from the data lake 607). These modules 610 include one or more of a behavior module, an inference module, a sessionization module, a modeling module, a data mining module, and a deep learning module. These modules can also, for example, be implemented by NiFi, Spark or TensorFlow, or combinations thereof. Unlike these the modules in the streaming analytics engine 604, the analysis done by the modules 610 is not streaming. The results are stored in memory (e.g. cache services 611), which then transmitted to the streaming analytics engine 604.

The resulting analytics, understanding data and prediction data, which are outputted by the streaming analytics engine 604, are transmitted to ingestors 606, via the message bus 605. The outputted data from the offline analytics and machine learning modules 610 can also be transmitted to the ingestors 606.

The ingestors 606 organize and store the data into the data lake 607, which comprise massive database frameworks. Non-limiting examples of these database frameworks include Hadoop, HBase, Kudu, Giraph, MongoDB, Parquet and MySQL. The data outputted from the ingestors 606 may also be inputted into a search platform 608. A non-limiting example of the search platform 608 is the SoIr search platform built on Apache Lucene. The SoIr search platform, for example, provides distributed indexing, load balanced querying, and automated failover and recovery.

Data from the data lake and the search engine are accessible by API services 609.

Turning to FIG. 7, another architecture 701 is shown, which used after the data has been stored in the data lake 607 and indexed into the search platform 608.

A core services module 702 obtains data from the search platform 608 and the data lake 607 and applies data science and machine learning services, distributed processing services, data persistence services to the obtained data. For example, the data science and machine learning services are implemented using one or more of the following technologies: NiFi, Spark, TensorFlow, Cloud Vision, Caffe, Kaldi, and Visage. It will be appreciated that other currently known and future known data science or machine learning platforms can be used to execute algorithms to process the data. Non-limiting examples of distributed processing services include NiFi and Spark.

The API services module 703 includes various APIs that interact with the core services module 702 and the applications 704. The API services module 703, for example, exchanges data with the applications in one or more of the following protocols: HTTP, Web Socket, Notification, and JSON. It will be appreciated that other currently known or future known data protocols can be used.

The module 703 includes an API gateway, which accesses various API services. Non-limiting examples of API service modules include an optimization services module, a search services module, an algorithm services module, a profile services module, an asynchronous services module, a notification services module, and a tracking services module.

In an example embodiment, the modules 703 and 702 are part of the AI platform 107, and the applications 704 reside on one or more of the data science servers 104, the internal applications and databases 105, and the user device 102. Non-limiting examples of the applications include enterprise business applications, AI applications, system management applications, and smart device applications.

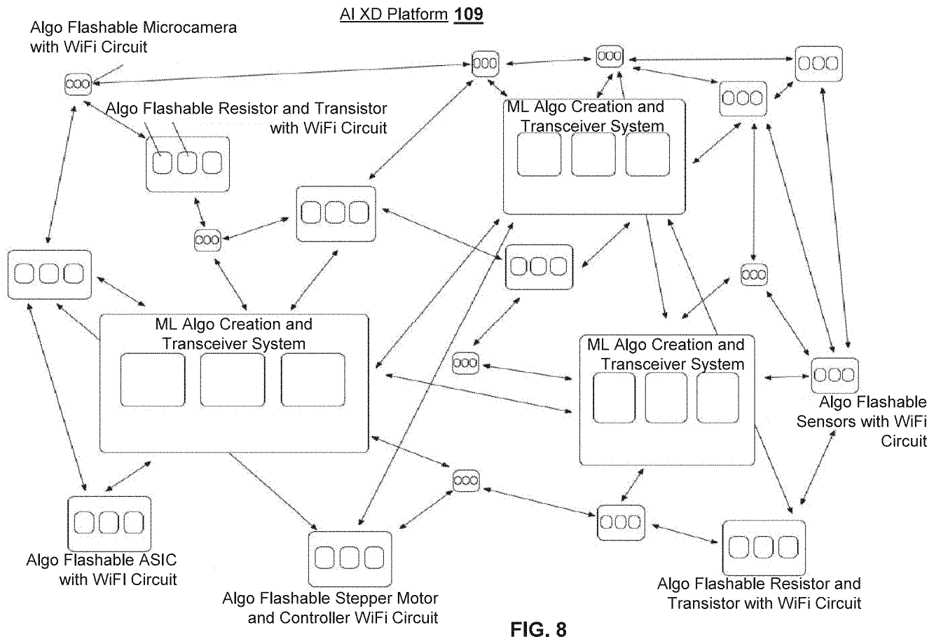

Turning to FIG. 8, an example embodiment of an AI XD platform 109 is shown, comprising various types of Intelligent Devices represented by different sized boxes, according to an embodiment described herein. The AI XD platform 109 includes, for example, a plurality of intelligent devices, intelligent device message buses, and networks. The various Intelligent Devices can be dispersed throughout the platform. Similar to a human brain with neurons and synapses, neurons can be considered akin to Intelligent Edge Nodes and synapses can be considered akin to Intelligent Networks. Hence, Intelligent Edge Nodes are distributed and consequently support the notion of distributed decision making—an important step and embodiment in performing XD decision science resulting in recommendations and actions. However, unlike the synapses of a human brain, the Intelligent Networks in the platform 109 as disclosed herein can have embedded “intelligence”, wherein intelligence can refer to the ability to perform data or decision science, execute relevant algorithms, and communicate with other devices and networks.

Intelligent Edge Nodes are a type of an Intelligent Device, and can comprise various types of computing devices or components such as processors, memory devices, storage devices, sensors, or other devices having at least one of these as a component. Intelligent Edge Nodes can have any combination of these as components. Each of the aforementioned components within a computing device may or may not have data or decision science embedded in the hardware, such as microcode data or decision science running in a GPU, data or decision science running within the operating system and applications, and data or decision science running as software complimenting the hardware and software computing device.

As shown in FIG. 8, the AI XD platform 109 can comprise various Intelligent Devices including, but not limited to, for example, an Algo Flashable Microcamera with WiFi Circuit, an Algo Flashable Resistor and Transistor with WiFi Circuit, an Algo Flashable ASIC with WiFi Circuit, an Algo Flashable Stepper Motor and Controller WiFi Circuit, Algo Flashable Circuits with WiFi Sensors, and an ML Algo Creation and Transceiver System. Intelligent Devices listed above may be “Algo Flashable” in a sense that the algorithms (e.g., data or decision science related algorithms) can be installed, removed, embedded, updated, loaded into each device. Other examples of Intelligent Devices include user devices and OCDs.

Each Intelligent Device in the platform 109 can perform general or specific types of data or decision science, as well as perform varying levels (e.g., complexity level) of computing capability (data or decision science compute, store, etc.). For example, Algo Flashable Sensors with WiFi circuit may perform more complex data science algorithms compared to those of Algo Flashable Resistor and Transistor with WiFi circuit, or vice versa. Each Intelligent Device can have intelligent components including, but not limited to, intelligent processors, RAM, disk drives, resistors, capacitors, relays, diodes, and other intelligent components. Intelligent Networks (represented as bi-directional arrows in FIG. 8) can comprise one or more combinations of both wired and wireless networks, wherein an Intelligent Network includes intelligence network devices, which are equipped with or configured to apply data or decision science capabilities.

Each Intelligent Device can be configured to automatically and autonomously query other Intelligent Devices in order to better analyze information and/or apply recommendations and actions based upon, or in concert with, one or more other Intelligent Devices and/or third party systems. This exemplifies applying perfect or near perfect information, by using as much data and data or decision science prior to taking an action given all information that is available at that specific moment.

Each Intelligent Device can also be configured to predict and determine which network or networks, wired or wireless, are optimal for communicating information based upon local and global parameters including but not limited to business rules, technical metrics, network traffic conditions, proposed network volume and content, and priority/severity levels, to name a few. An Intelligent Device can optionally select a multitude of different network methods to send and receive information, either in serial or in parallel. An Intelligent Device can optionally determine that latency in certain networks are too long or that a certain network has been compromised, for example, by providing or implementing security protocols, and can reroute content using different encryption methods and/or reroute to different networks. An Intelligent Device can optionally define a path via for example nodes and networks for its content. An Intelligent Device can optionally use an Intelligent Device Message Bus to communicate certain types of messages (e.g. business alerts, system failures) to other Intelligent Devices. One or more Intelligent Device Message Buses can connect multiple devices and/or networks.

Each Intelligent Device can optionally have an ability to reduce noise and in particular, to reduce extreme data, especially at the local level or through the entire platform 109. This may provide the platform 109 the ability to identify eminent trends and to make preemptive business and technical recommendations and actions faster, especially since less duplicative data or extreme data allows for faster identification and recommendations.

Each Intelligent Device can include data or decision science software including but not limited to operating systems, applications, and databases, which directly support the data or decision science driven Intelligent Device actions. Linux, Android, MySQL, Hive, and Titan or other software could reside on SoC devices so that the local data or decision science can query local, on device, related data to make faster recommendations and actions.

Each Intelligent Device can optionally have an Intelligent Policy and Rules System. The Intelligent Policy and Rules System provides governing policies, guidelines, business rules, nominal operating states, anomaly states, responses, key performance indicator (KPI_metrics, and other policies and rules so that the distributed IDC devices can make local and informed autonomous actions following the perfect information guiding premise as mentioned above. A number (e.g., NIPRS) of Intelligent Policy and Rules Systems can exist, and the aforementioned systems can have either identical, or differing policies and rules amongst themselves or alternatively can have varying degrees or subsets of policies and rules. This latter alternative is important when there are localized business and technical conditions that may not be appropriate for other domains or geographic regions.

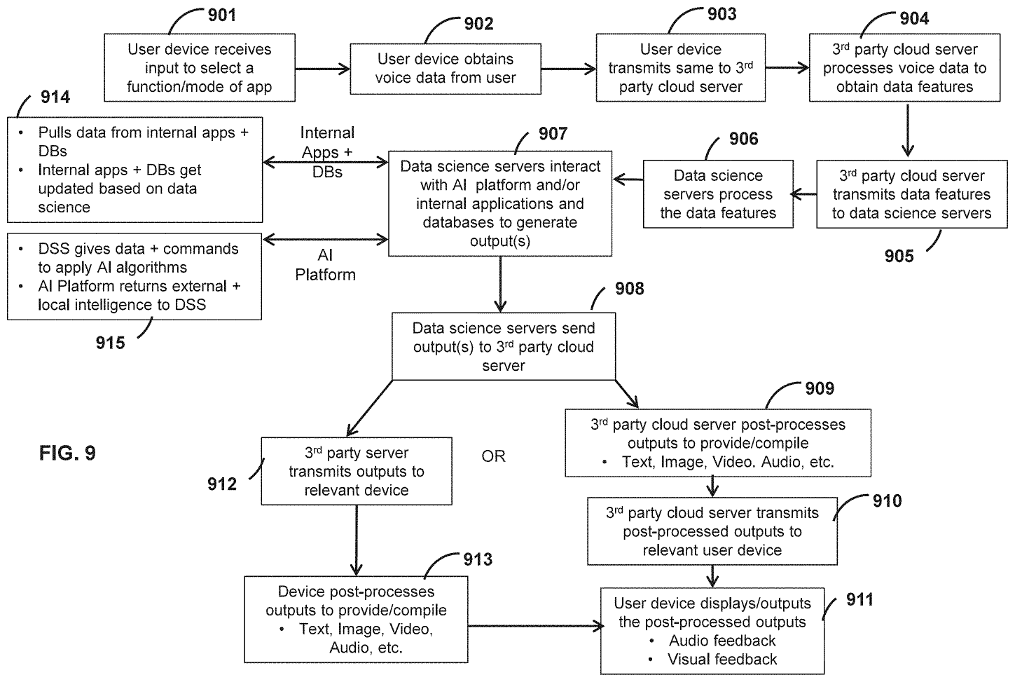

Turning to FIG. 9, example computer executable instructions are provided for processing data using the data enablement platform. At block 909, a user device or an OCD, or both, receives input to select a function or a mode of an application (e.g. the data enablement application) that resides on the user device. At block 902, the user device or the OCD, or both, obtains voice data from a user. At block 903, the user device or the OCD, or both, transmits the same data to the 3^{rd} party cloud computing servers. The user device also transmits, for example, contextual data. At block 904, the 3^{rd} party cloud computing servers processes the voice data to obtain data features.

Non-limiting examples of extracted data features include text, sentiment, action tags (e.g. commands, requests, questions, urgency, etc.), voice features, etc. Non-limiting examples of contextual features include the user information, device information, location, function or mode of the data enablement application, and a date and time tag.

The extracted data features and the contextual features are transmitted to the data science servers (block 905). The original data (e.g. raw audio data) may also be transmitted to the data science servers. At block 906, the data science servers process this received data.

At block 907, the data science servers interact with the AI platform, or the internal applications and internal databases, or both, to generate one or more outputs.

The data science servers then send the one or more outputs to the 3^{rd} party cloud computing servers (block 908). In one example embodiment, the 3^{rd} party cloud computing servers post-processes the outputs to provide or compile text, image, video or audio data, or combinations thereof (block 909). At block 910, the 3^{rd} party cloud computing servers transmit the post-processed outputs to the relevant user device(s) or OCD(s). At block 911, the user device(s) or the OCD(s), or both, output the post-processed outputs, for example, via an audio device or a display device, or both.

In an alternative embodiment, stemming from block 908, the 3^{rd} party cloud computing server transmits the outputs to the one or more relevant devices (e.g. user devices or OCDs) at block 912. The post-processing is then executed locally on the one or more relevant devices (block 913). These post-processed outputs are then outputted via audio devices or visual devices, or both on the one or more user devices or OCDs (block 911).

Turning back to block 907, in an example aspect, the data science servers pull data from the internal applications and internal databases, or the internal applications and internal database are updated based on the results produced by the data science servers, or both (block 914).

In another example aspect, the data science servers transmit data and commands to the AI platform, to apply AI processes on the transmitted data. In return, the AI platform transmits external and local information and data intelligence to the data science servers. These operations are shown in block 915.

It can be appreciated that any two or more of the operations in blocks 907, 914, and 915 can affect each other. In an example embodiment, the outputs of block 914 are used in the operations of block 915. In another example embodiment, the outputs of block 915 are used in the operations of block 914.

It is herein recognized that the devices, systems and the methods described herein enable the provision of relevant digital media content specific to the interest of a given user.

The devices in combination with the data enablement platform provides people with “Perfect Information”, a concept from economists.

The data enable platform described herein, in combination with the user device or the OCD, or both, provide perfect information to help a person consume digital media content and to interact with the digital media content. A user, for example, talks with a bot on the user device or the OCD.

In preferred embodiments, the bot is chatbot that has language capabilities to interact with the user via text language or spoken language or both. However, in other example embodiment, the bot does not necessarily chat with a user, but still affects the display of data being presented to the user.

The systems described herein provide a digital magazine collection with intelligent bots tied to each digital magazine. Each digital magazine is created or customized by a user and that represents a topic, theme, interest, hobby, research project, etc. For example, a user can orally speak into the application and say, “Hey Bot, create a black hole entanglement magazine.” The application, in turn, creates a digital magazine, selects a picture from the web depicting black hole entanglement, and displays words below the picture stating “Black hole entanglement.”

It will be appreciated that the term “digital magazine” herein refers to unified collection of data focused on given topic. The data includes, for example, one or more of text data, audio data and visual data (e.g. images or video, or both).

One of the application bots begins autonomously searching the Internet news, blogs, forums, periodicals, magazines, social sites, video sites, etc. multimedia (text, audio, video, pictures) that closely match the key words and phrase “black hole entanglement”. This bot uses data science, such as, but not limited to, K Means clustering, to identify attributes and characteristics that most closely reflect the attributes and characteristics of black hole entanglement.

The user subsequently selects the black hole entanglement digital magazine and consequently the digital magazine begins displaying summary information, pictures, article, videos, etc. of information specific to black hole entanglement based upon the data science.

The user can orally or manually say in relation to each multimedia picture, text, audio, video, whether he or she likes or dislikes the content. A separate machine learning bot tied to the black hole entanglement digital magazine begins learning what the user likes and dislikes about the K Means results and subsequently tunes the data science to present results that are more like the machine learned user “likes”.

The user can also orally comment on the content (e.g. This theory sounds familiar; or The new satellite from ABC Inc. should provide more facts that support this theory). The data enablement platform uses this information to provide related information in the same digital magazine.

In a particular example, as the user reads, listens, or watches a multimedia piece, the user can tell the application to pause. At this pause point, the user can create voice and typed in bot notes linked to a key words, phrases, pictures, video frames, sound bytes in the multimedia—a pause point bot. These user created bot notes enable the user to insert thoughts, comments, reminders, to do's etc. and are indexed for future access. At this pause point, in an alternative embodiment, the user can perform a search using search engines such as Google or Bing. If the user likes one of the results from the search results page, the user can orally connect that linked multimedia to the digital magazine pause point for future reference. At this pause point, in an alternative embodiment, the user can orally link to a different web site, forum, blog, forum, etc., search for results, and link this resulting information back to the pause point. The pause point bot can simultaneously begin searching for other Internet multimedia documents, apply K means to the results and recommend other multimedia documents that are very similar to each comment, to do, reminder, search result link, forum, blogs, news, periodical, etc—this is akin to people who saw these results for a topic also searched and found X multimedia, with has characteristics and attributes closely related to a specific thought, to do, video, etc.

As the user reads, listens, and adds more related comments, notes, links, etc, to the black hole entanglement digital magazine, the user has the option to publish and share his digital magazine(s) with other people via social media, forums, blogs, etc.

As the user reads, listens, and adds more related comments, notes, links, etc. to the black hole entanglement digital magazine, the user can create documents, take pictures/videos, record audio, input IoT data and associate the aforementioned data to the black hole entanglement baseball digital magazine.

As the user adds oral comments to the digital magazine, a bot applies sentiment analysis to the orally spoken comments creating meta data that can help the machine learning bots understand excitement, sadness, etc. toward a piece (e.g. an article, a video, a blog entry, an audio cast or podcast, etc.) in the digital magazine.

As the user adds oral, picture, and video comments to the digital magazine, a bot can record/observe for background noise, background picture/video elements (location, color, people, objects) creating meta data that can help the machine learning bots to better understand context or the environment of where a user is consuming the black hole entanglement digital magazine. For example, the data enablement platform determines if the user consuming the media while on a train, or on a plane, or in a bathroom, or at a park, or with people around them, etc.

A digital magazine bot can also perform a visual graph data representation showing how all of the black hole entanglement media pieces are related to one another for easy future access as well as propose and recommend other media articles, web site, news, blogs, and forums to view and potentially add to the black hole entanglement digital magazine.

The digital enablement platform also enables other people to follow a user's specific digital magazine if the digital magazine creator publishes and allows people to follow this digital magazine.

In an example aspect, a person who has created a digital magazine for a certain topic can adjust settings that direct the data enablement platform to privately share the given digital magazine with selected contacts, or to be shared publicly.

The system enables the digital magazine creator to receive comments, questions, links, digital media and to decide whether to add this submitted information to the existing black hole entanglement digital magazine.

In an example aspect, the results of the aforementioned information on a specific topic, theme, interest, etc. results in the closest, real time, perfect information digital magazine.

The user (e.g. digital magazine creator) no longer needs to spend as much time searching for existing content and can spend more time on creating new content or learning about new content.

Based on these technical features, in effect to the user, a user who is an enthusiast no longer has to do searches that are deep and relevant to the user's theme, topic of interest. The data enablement platform and the user device pull the information together for the user in an easy to consume and interact format.

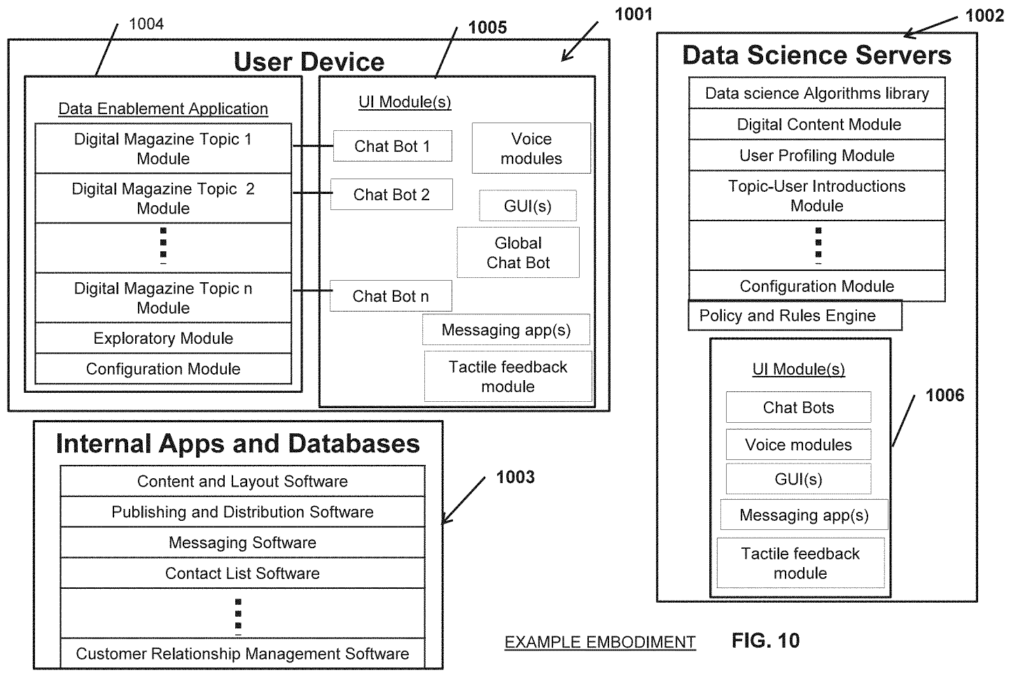

Turning to FIG. 10, an example embodiment is provided of software modules that reside on a given user device 1001, data science servers 1002, and internal applications and databases 1003, which are suited for generating and publishing digital magazines, and interacting with the same.

For example, a data enablement application 1004 resides on the user device and the application includes: a first digital magazine module for Topic 1, a second digital magazine module for Topic 2, and so forth, an exploratory module, and a configuration module. The user device also includes user interface (UI) modules 1005, which can be part of the data enablement application 1004, or may interact with the data enablement application 1004. The UI modules includes chat bots that are associated with, or part of, each digital magazine. For example, ChatBot 1 is linked to the first digital magazine module for Topic 1, and ChatBot 2 is linked to the second digital magazine for Topic 2. There is also a global chatbot that interfaces with the overall application 1004 and with other magazine-specific chatbots (e.g. ChatBot 1 and ChatBot 2). The UI modules also include one or more GUIs, synthesizer voice modules, one or more messaging application, and one or more tactile feedback modules, or combinations thereof.

In an example embodiment, the exploratory module helps a user to explore different topics, different sub-topics, and different data sources.

The data science servers 1002 include a data science algorithms library, a digital content module, a user profiling module, a topic-user introductions module, a configuration module, and a policy and rules engine. For example, the policy and rules engine includes policies and rules that are specific to the company or organization using the data enablement platform.

Regarding the data science algorithms library, it will be appreciated that data science herein refers to math and science applied to data in the form including but not limited to algorithms, machine learning, artificial science, neutral networks, etc. The results from data science include, but are not limited to, business and technical trends, recommendations, actions, trends, etc.

In an example aspect, Surface, Trend, Recommend, Infer, Predict and Action (STRIPA) algorithms are included in the data science algorithms library. This family of STRIPA algorithms worth together and are used to classify specific types of data science to related classes.

Non-limiting examples of other data science algorithms that are in the data science library include: Word2vec Representation Learning; Sentiment (e.g. multi-modal, aspect, contextual, etc.); Negation cue, scope detection; Topic classification; TF-IDF Feature Vector; Entity Extraction; Document summary; Pagerank; Modularity; Induced subgraph; Bi-graph propagation; Label propagation for inference; Breadth First Search; Eigen-centrality, in/out-degree; Monte Carlo Markov Chain (MCMC) simulation on GPU; Deep Learning with region based convolutional neural networks (R-CNN); Torch, Caffe, Torch on GPU; Logo detection; ImageNet, GoogleNet object detection; SIFT, SegNet Regions of interest; Sequence Learning for combined NLP & Image; K-means, Hierarchical Clustering; Decision Trees; Linear, Logistic regression; Affinity Association rules; Naive Bayes; Support Vector Machine (SVM); Trend time series; Burst anomaly detection; KNN classifier; Language Detection; Surface contextual Sentiment, Trend, Recommendation; Emerging Trends; Whats Unique Finder; Real-time event Trends; Trend Insights; Related Query Suggestions; Entity Relationship Graph of Users, products, brands, companies; Entity Inference: Geo, Age, Gender, Demog, etc.; Topic classification; Aspect based NLP (Word2Vec, NLP query, etc.); Analytics and reporting; Video & audio recognition; Intent prediction; Optimal path to result; Attribution based optimization; Search and finding; and Network based optimization.

In other example embodiments, the aforementioned data science can reside on the user's smartphone, or in public or private clouds, or at the employee's data center, or any combination of the aforementioned.

Continuing with FIG. 10, UI modules 1006 also reside on the data science servers 1004.

The internal applications and database 1003 also include various software and database that are used to assist in management of the digital media content. These include digital content and layout software, publishing and distribution software, messaging software, contact list software, and Customer Relationship Management (CRM) software.

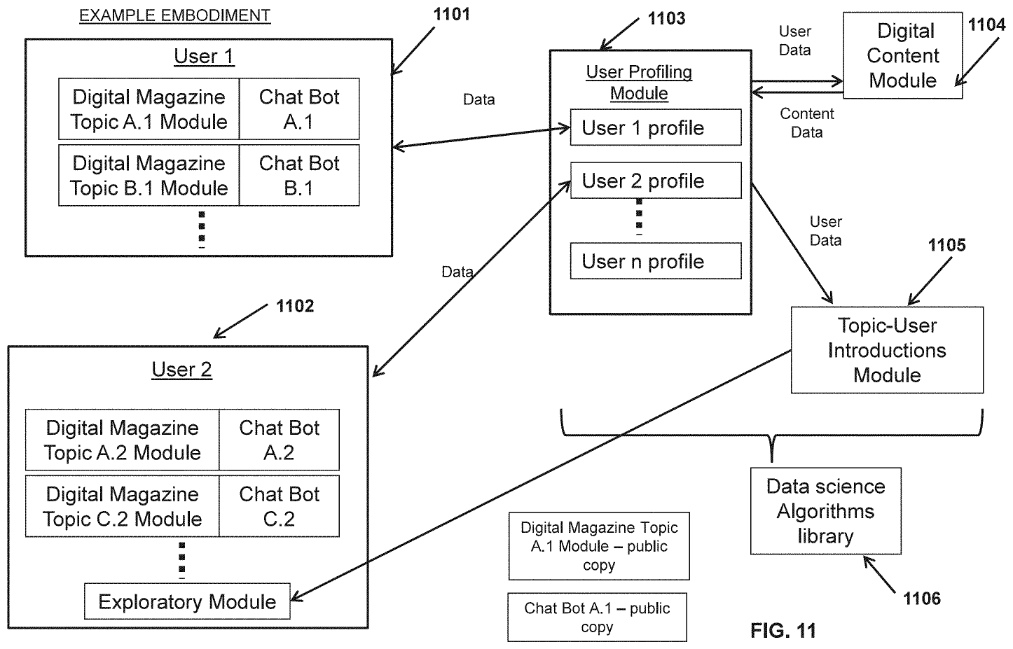

Turning to FIG. 11, an example data flow diagram shows the flow of data between different modules. User devices 1101 and 1102 belonging respectively to User 1 and User 2 have stored thereon digital magazine modules. Alternatively, these modules do not reside in memory on the user device, but are accessible via a web portal, which the user can log into with their user account. In particular, for User 1, there is a Digital Magazine Topic A.1 module, which represents a digital magazine for Topic A specific to User 1, and this module is associated with ChatBot A.1. Also associated with User 1 is a Digital Magazine Topic B.1 module, which represents a different digital magazine for Topic B and specific to User 1. This module is associated with ChatBot B.1.

For User 2, there is a Digital Magazine Topic A.2 module, which represents a digital magazine for Topic A specific to User 2, and this module is associated with ChatBot A.2. Also associated with User 2 is a Digital Magazine Topic C.2 module, which represents a different digital magazine for Topic C and specific to User 2. This module is associated with ChatBot C.2. Although User 2 and User 1 both have digital magazines focused on Topic A, their magazines may be different based on their behaviors, inputted data, and other interests. Also, their chatbots (e.g. ChatBot A.1 and ChatBot A.2) also evolve differently to suit their specific user (e.g. respectively User 1 and User 2).

Data from each of the users are transmitted into the user profiling module 1103. Examples of transmitted data include voice notes, video data, text data, time, swipe or gesture data, other audio data, user device data, etc. In an example embodiment, the raw data obtained from the user device is pre-processed on the user device to extract data features, and these data features are also transmitted to the user profiling module 1103.

The user profiling module organizes and stores the data for each user profile. For example, data from User 1 is stored in the User 1 profile, and data from User 2 is stored in the User 2 profile.

Based on the user profile data and the data science algorithms, as obtained from the data science algorithms library 1106, the digital content module 1104 procures digital media content that is appropriate and relevant for a given user. It then returns the digital media content back to the user profiling module 1103 for distribution to the respective users.

Over time, as ChatBot A.1 learns more about User 1 and more about Topic A, ChatBot A.1 will evolve using currently known and future known artificial intelligence computing techniques. Similarly, over time, as ChatBot A.2 learns more about User 2 and more about Topic A, ChatBot A.2 will evolve using currently known and future known artificial intelligence computing techniques. Over time, ChatBot A.1 can become very different and much more complex than ChatBot A.2. Similarly, the resulting digital magazines for Topic A for User 1 and for User 2 can become quite different.

The topic-user introductions module 1105 may identify that the Digital Magazine Topic A.1 Module or ChatBot A.1, or both, are different (e.g. better) than the counterpart module and chatbot of User 2. Therefore, assuming sharing or publication permissions from User 1 are provided, the module 1105 transmits or makes available to User 2 a public copy of Digital Magazine Topic A.1 Module or ChatBot A.1, or both. This data, for example, is sent to the exploratory module of User 2.

In an example aspect, inputted data from User 1, such as notes, highlights, comments, images, video, etc., are part of the public copy of Digital Magazine Topic A.1 Module. In another example aspect, this inputted data is not part of the public copy of Digital Magazine Topic A.1 Module, and, if User 1 permits, is sent separately to another user (e.g. User 2).

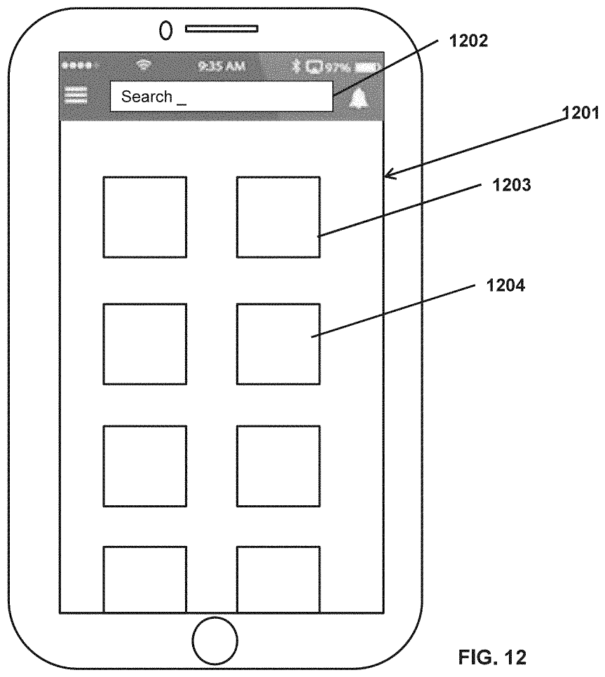

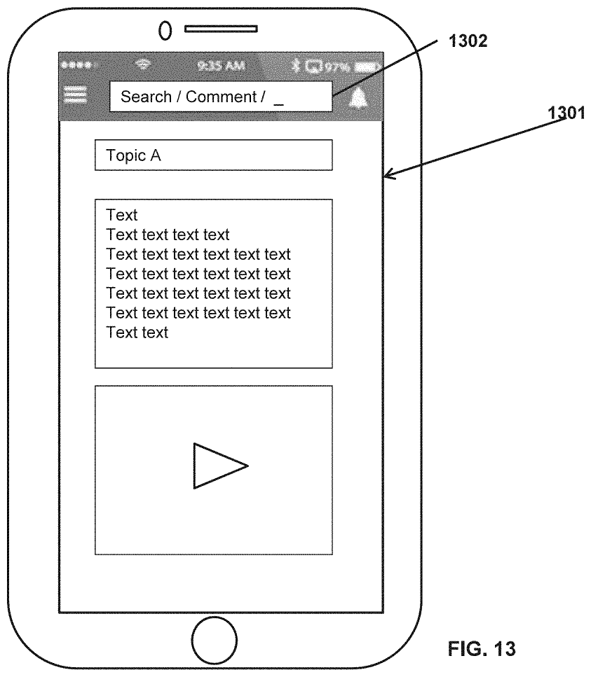

FIGS. 12 and 13 include screenshots of example GUIs shown for applying the data enablement system to the display of a digital magazine.

In FIG. 12, a home landing page 1201 is shown for the data enablement application. It includes a search field 1202 to receive text input for topics, names, things, etc. A user can also speak to the global chatbot to explore or search for topics, names, things, etc. It also includes GUI controls 1203, 1203 for activating each digital magazine. For example, the control 1203 represents a digital magazine about black hole entanglement and the control 1204 represents a different digital magazine about gardening in desert climates. By receiving a selection (e.g. either through a GUI or by an oral command) of one of these controls, the user device will launch a GUI specific to the selected digital magazine and will activate the corresponding chatbot.

FIG. 13 shows an example GUI 1301 of a selected digital magazine. The layout and format of the content can change over time, and can vary from user to user. The GUI can include text, video, or images, or a combination thereof. A text field 1302 receives text input to initiate searches or to store comments related to a given digital media piece. The display of visual content can be scrolled up or down, or can be presented as pages that can be turned over.

By selecting a piece of content in the GUI, the chat bot begins to read aloud the content.

It is appreciated that the content in the digital magazine can be updated in realtime, even while the user is viewing the digital magazine, as content is procured by data enablement platform.

The depicted control elements are for example. Other control elements with different data science, bots, features, and functionality may be added and mixed with other control elements.

Below are example questions and statement posed by a user, and oral feedback provided by the chatbot. It will be appreciated that the bot or chatbot is conversational and adapts to the style of the user to which it is speaking.

### Example 1

User: Hey Bot, provide me with articles about topic X.
Bot: Hey User, here are the most recent articles about topic X and the most cited articles about topic X.
The Bot reads out summaries of the latest 3 new articles pulled from various data sources, and reads out summaries of the 3 most cited articles.

### Example 2

User: Hey Bot, read article XYZ for me.
Bot reads out the article XYZ.
User: Hey Bot, please repeat the last few sentences.
Bot re-reads the last three sentences, pauses, and then continues reading the rest of article XYZ.
reads out summaries of the 3 most cited articles.

### Example 3

User: Hey Bot, read article XYZ for me.
Bot reads out the article XYZ.
User: Hey Bot, I think the perspective on theory R is interesting. Professor P is doing some research to disprove it.
Bot: Hey User, I have found more content about theory R, articles from Professor P about theory R, and other content about disproving theory R. Do you want to hear this content now or save it for later?
User: Hey Bot, continue reading the article and then read me the articles from Professor P.
Bot continues to read out the article XYZ. Afterwards, Bot reads out the articles from Professor P.

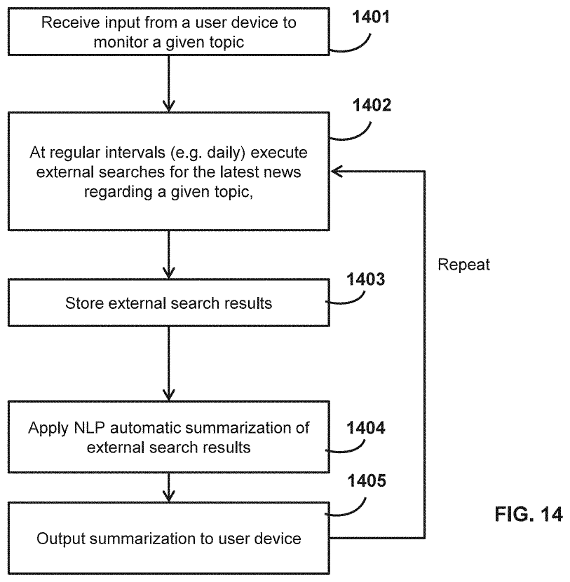

Turning to FIG. 14, an example computation is shown for applying natural language processing (NLP). At block 1401, the user device or the OCD receives input to monitor a given topic. At block 1402, at regular intervals (e.g. daily), the data enablement platform executes external searches for the latest news regarding a given topic. At block 1403, the external search results are stored in memory. At block 1404, the data enablement platform applies NLP automatic summarization of the search results and outputs the summarization to the user device (e.g. via audio feedback) (block 1405). The process then repeats at regular intervals, as per block 1402.

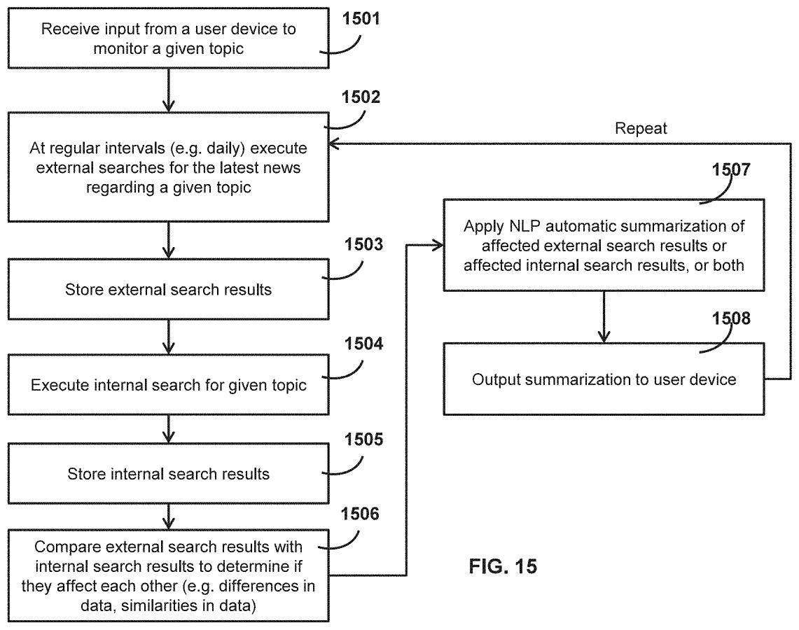

Turning to FIG. 15, another example computation is provided. At block 1501, the user device or the OCD receives input to monitor a given topic. At block 1502, at regular intervals (e.g. daily), the data enablement platform executes external searches for the latest news regarding a given topic. At block 1503, the external search results are stored in memory. At block 1504, the data enablement platform executed internal searches for the given topic. At block 1505, these internal search results are stored. At block 1506, the data enablement platform compares the external search results with the internal search results to determine if they affect each other. For example, the data enablement platform determines if there are differences in the data or similarities in the data, or both. At block 1507, the data enablement platform applies NLP automatic summarization of the affected external search results, or the affected internal search results, or both. The summarization is outputted to the user device for visual display or audio feedback (block 1508). In this way, a user is informed of relevant news and why the news is relevant (e.g. affected internal data, etc.).

In an example embodiment, the above methods in FIG. 14 or 15 are used to provide a bot, or chatbot, that provides a fast and easy way to consume news summaries (e.g. news releases, investigative articles, documentaries, LinkedIn, Facebook fan page, etc.) for each specific topic.

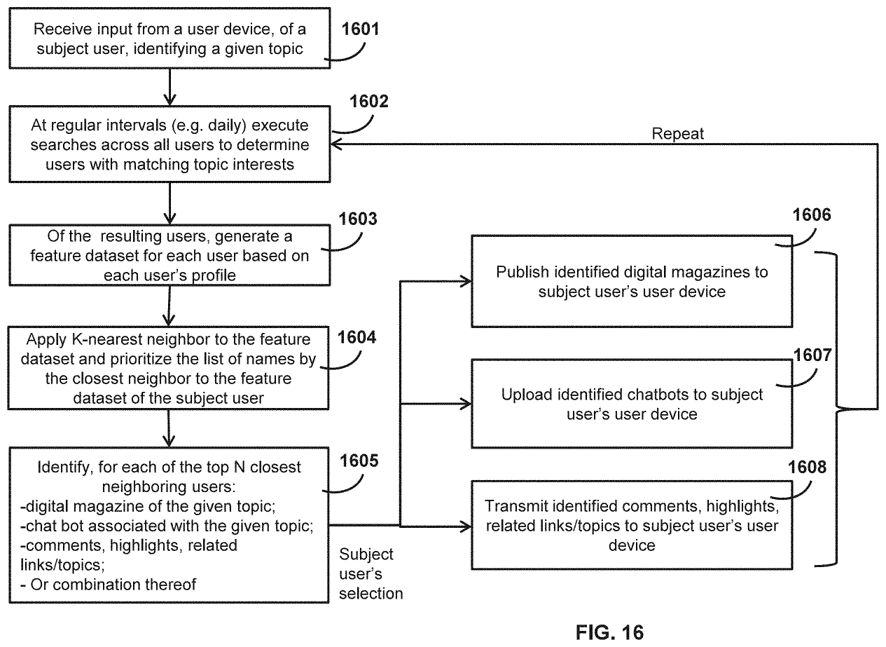

Turning to FIG. 16, example executable instructions are provided for using K-nearest neighbor computations to identify other users that have similar features.

Block 1601: Receive input from a user device, of a subject user, identifying a given topic.

Block 1602: At regular intervals (e.g. daily), the data enablement platform executes searches across all users to determine users with matching topic interests.

Block 1603: Of the resulting users, the data enablement platform generates a feature dataset for each user based on each user's profile.

Block 1604: The data enablement platform applies K-nearest neighbor computation to the feature dataset and prioritizes the list of names by the closest neighbor to the feature dataset of the subject user.

Block 1605: The data enablement platform identifies, for each of the top N closest neighboring users: digital magazine of the given topic; or chat bot associated with the given topic; or comments, highlights, related links/topics; or a combination thereof.

The data enablement platform then executes the operations in one or more of blocks 1606, 1607 and 1608.

Block 1606: Publish identified digital magazines to subject user's user device.

Block 1607: Upload identified chatbots to subject user's user device.

Block 1608: Transmit identified comments, highlights, related links/topics to subject user's user device.

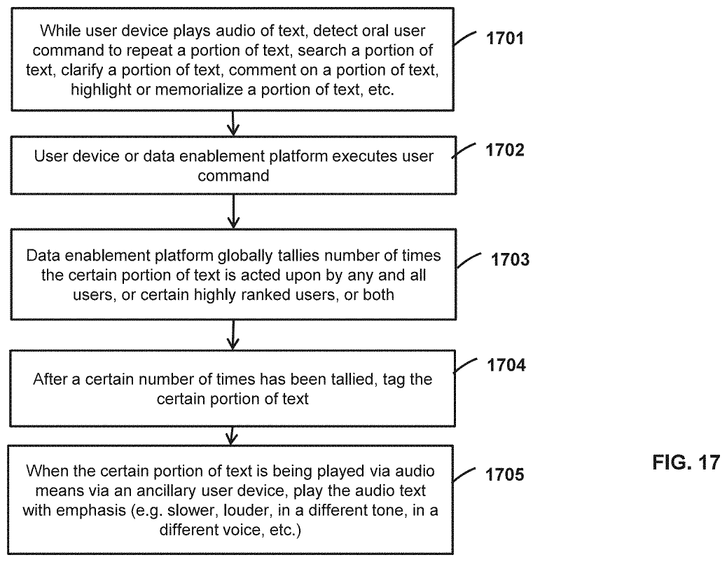

Turning to FIG. 17, example executable instructions are provided for using dynamic searches to affect the way certain data is outputted at the user device.

Block 1701: While the user device plays audio of text, the user device detects a user's oral command to at least one of: repeat a portion of text, search a portion of text, clarify a portion of text, comment on a portion of text, highlight or memorialize a portion of text, etc.

Block 1702: The user device or the data enablement platform, or both, executes the user's command.

Block 1703: The data enablement platform globally tallies the number of times the certain portion of text is acted upon by any and all users, or certain highly ranked users, or both.

Block 1704: After a certain number of times has been counted, the data enablement platform tags the certain portion of text.

Block 1705: When the certain portion of text, which is tagged, is being played via audio means via an ancillary user device, the user device plays the audio text with emphasis (e.g. slower, louder, in a different tone, in a different voice, etc.). In other words, the data enablement platform has tagged the certain portion of the text and has performed an audio transformation on the certain portion of text.

Therefore, if User 1 comments on some text or audio or video, when User 2 reviews the same data, the chatbot for User 2 will read out the text with emphasis. In an example embodiment, User 2 does not know what comments are, but only that the portion of text was considered important by many users.

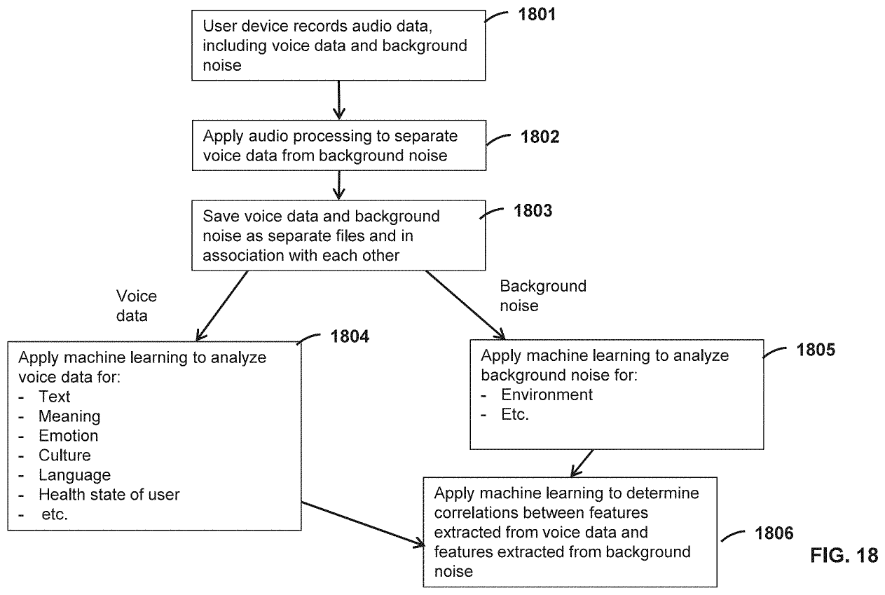

Turning to FIG. 18, example executable instructions are provided for processing voice data and background noise.

Block 1801: The user device or the OCD records audio data, including voice data and background noise.

Block 1802: The data enablement platform applies audio processing to separate voice data from background noise.

Block 1803: The data enablement platform saves the voice data and the background noise as separate files and in association with each other.

Block 1804: The data enablement platform applies machine learning to analyze voice data for: text; meaning; emotion; culture; language; health state of user; etc.

Block 1805: The data enablement platform applies machine learning to analyze background noise for: environment, current activity engaged by user, etc.

Block 1806: The data enablement platform applies machine learning to determine correlations between features extracted from voice data and features extracted from background noise.

In this way, information about the user can be more accurately determined, such as their behavior and their surroundings. This information is stored as part of a given user profile (e.g. User 1 Profile, User 2 Profile, etc.). This in turn can be used curate more relevant content to a user, identify similar users, format the output of the content (e.g. language, speed of reading, volume, visual layout, font, etc.) to meet the profile of the user, and provide data to publishers and content producers to generate more relevant content.

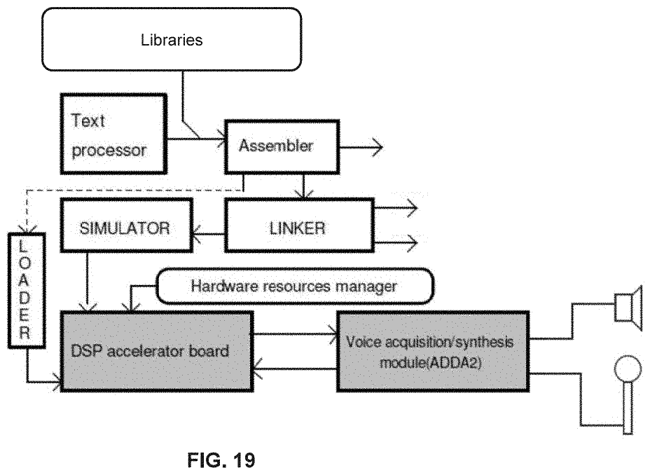

In an example embodiment, the user device, including and not limited to the OCD, includes an onboard voice synthesizer to generate synthesized voices. Turning to FIG. 19, the onboard voice synthesizer is a Digital Signal Processing (DSP) based system that resides on the user device. It includes one or more voice libraries. It also includes a text processor, an assembler, a linker module, a simulator, a loader, a DSP accelerator module which is managed by a hardware resources manager, and a voice acquisition and synthesis module (e.g. an analog/digital converter and digital/analog converter). The voice acquisition and synthesis module is in data communication with a microphone and an audio speaker.

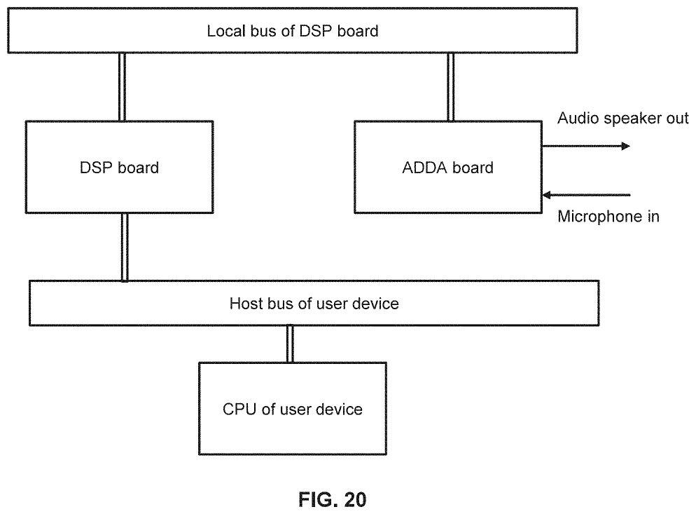

FIG. 20 shows an example subset of components on a user device, which includes a DSP board/chip, an ADDA2 board/chip, a local bus of the DSP board, a host bus, and a CPU of the smart device. These components, for example, support the software architecture shown in FIG. 19.

It will be appreciated that different software and component architectures (i.e. different from the example architectures shown in FIGS. 19 and 20) in a user device can be used to facilitate outputting synthesized voice data.

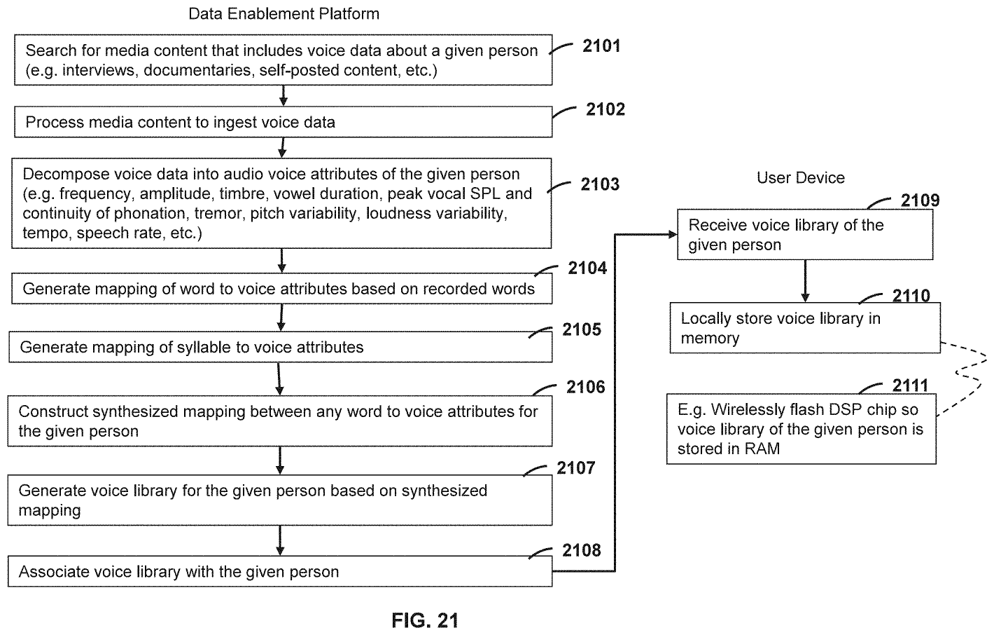

Turning to FIG. 21, example executable instructions are provided for building a voice library.

Block 2101: The data enablement platform searches for media content that includes voice data about a given person (e.g. interviews, documentaries, self-posted content, etc.). Example data formats of media content with voice data include videos and audio-only media.

Block 2102: The data enablement platform processes the media content to ingest the voice data.

Block 2103: The data enablement platform decomposes the voice data into audio voice attributes of the given person. Examples of audio voice attributes include frequency, amplitude, timbre, vowel duration, peak vocal sound pressure level (SPL), continuity of phonation, tremor, pitch variability, loudness variability, tempo, speech rate, etc.

Block 2104: The data enablement platform generates a mapping of word to voice attributes based on the recorded words.

Block 2105: The data enablement platform generates a mapping of syllable to voice attributes.

Block 2106: The data enablement platform constructs a synthesized mapping between any word to voice attributes for the given person.

Block 2107: The data enablement platform generates a voice library for the given person based on synthesized mapping.

Block 2108: The data enablement platform associates the voice library with the given person.

Block 2109: The user device that belongs to the user receives the voice library of the given person.

Block 2110: The user device of locally stores the voice library in memory. For example, the system wirelessly flashes the DSP chip so that the voice library of the given person is stored in RAM on the smart device (block 2111). This data can also be stored in some other manner on the user device.

For example, different voice libraries can be obtained for the voices of journalists, authors, a person being interviewed or quoted in a digital magazine, or of readers that comment on a digital magazine, or a combination thereof.

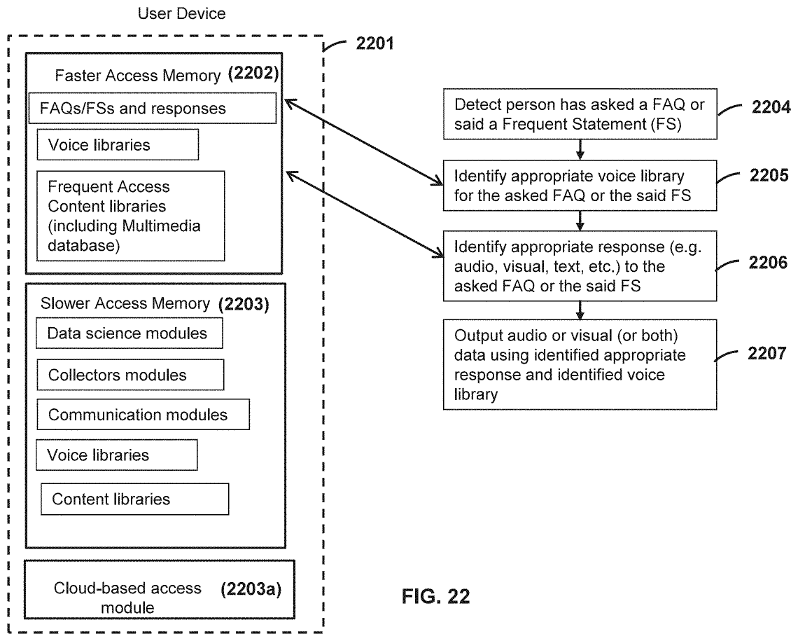

FIG. 22 shows an example of memory devices 2201 on a user device. The memory devices include faster access memory 2202 and slower access memory 2203. In one example embodiment, the faster access memory is RAM and the slower access memory is ROM. Other combinations of faster and slower memory devices can be used in alternative to RAM and ROM.

The faster access memory 2202 has stored on it, amongst other things, a library of frequently asked questions (FAQs) and frequent statements (FSs), and corresponding responses to these FAQs and FSs. The faster access memory also has stored on it voice libraries of persons who interact with the user, and a frequently accessed content libraries. These frequently accessed content libraries include multimedia. The information or content stored in memory 2202 provides local, edge, fast “hot” reacting content that is frequently needed, so that there is no need to go to the data enablement platform for same known-known data.

The slower access memory 2203 includes, amongst other things: data science modules, collectors modules, communication modules, other voice libraries, and content libraries. The information or content stored in memory 2203 provides local, edge, fast “medium” reacting content that is needed, but not as frequently or immediately, so that there is no need to go to the data enablement platform for same known-known data.

Another data module called the cloud-based access module 2203a allows for the user device to interact with the data enablement platform to access content libraries. This is also called cloud “cold” reacting content that is relatively less frequently used.

Block 2204: The user device detects a user has asked a FAQ or said a FS.

Block 2205: The user device accesses the faster access memory 2202 and identifies an appropriate voice library for the asked FAQ or the said FS.

Block 2206: The user device accesses the faster access memory 2202 and identifies the appropriate response (e.g. audio, visual, text, etc.) to the asked FAQ or the said FS.

Block 2207: The user device outputs audio or visual (or both) data using the identified appropriate response and the identified voice library. In this way, responses to FAQs and FSs occur very quickly, or even in real time, so provide a conversation like experience.

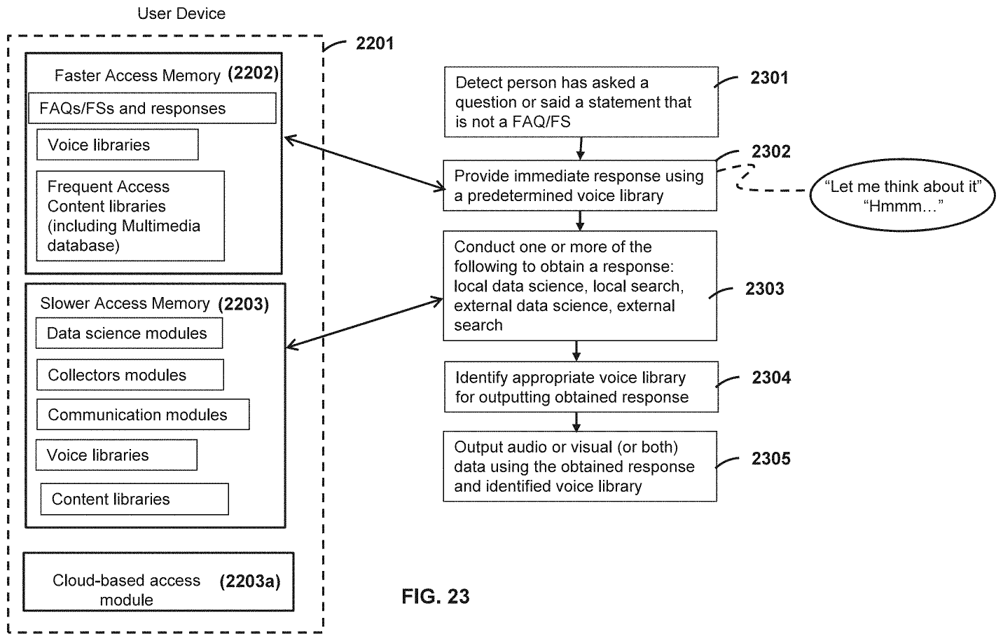

Turning to FIG. 23, another example set of executable instructions are executed by the smart device of the patient.

Block 2301: The user device detects the person has asked a question or said a statement that is not a FAQ/FS.

Block 2302: The user device provides an immediate response using a predetermined voice library. For example, the smart device says “Let me think about it” or “Hmmm”. This response, for example, is preloaded into the faster access memory 2202 for immediate retrieval.

Block 2303: The user device conducts one or more of the following to obtain a response: local data science, local search, external data science, and external search. This operation, for example, includes accessing the slower access memory 2203.

Block 2304: The user device identifies an appropriate voice library for outputting the obtained response.

Block 2305: The user device outputs audio or visual (or both) data using the obtained response and identified voice library.

In this way, more complex algorithms are computed locally on the user device, either in part or in whole, while still providing an immediate response.

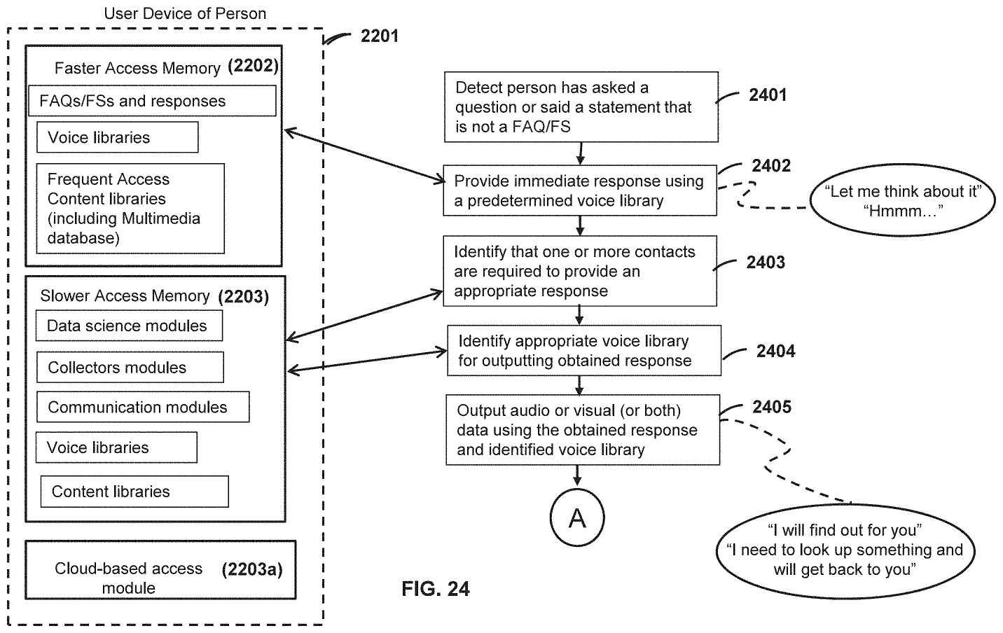

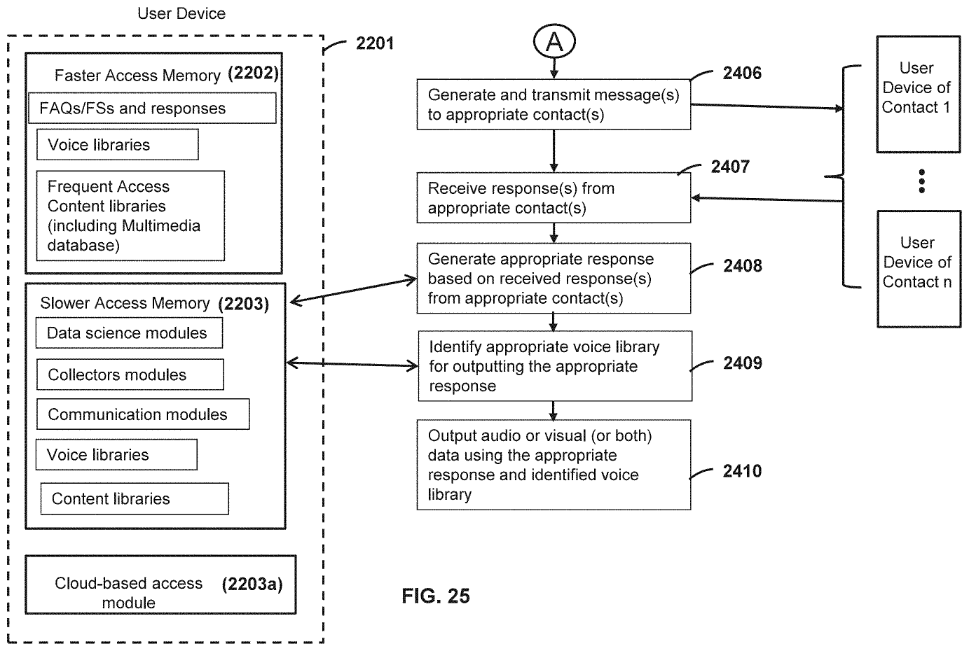

FIGS. 24 and 25 show another example embodiment of executable instructions executed by a user device of a user. If an answer to a user's question or statement is not known, then the user device initiates a message or communication session with a computing device belonging to a relevant contact of the user (e.g. another person that is interacting with the digital media content, the journalist or author of the digital media content, a friend or co-worker that could have a shared interest in the digital media content, etc.).

Block 2401: The user device detects that the user has asked a question or said a statement that is not a FAQ/FS.

Block 2402: The user device provides an immediate response using a predetermined voice library. For example, the smart device accesses the faster access memory 2202.

Block 2403: The user device identifies that one or more contacts are required to provide an appropriate response. For example, the user device accesses the slower access memory 2203 to obtain this information.

Block 2404: The user device identifies an appropriate voice library for outputting obtained response. For example, the user device accesses the slower access memory 3103 to obtain this information.

Block 2405: The user device outputs audio or visual (or both) data using the obtained response and identified voice library. For example, the smart device says: “I will find out for you” or “I need to look up something and will get back to you”.

Block 2406: The user device generates and transmits message(s) to appropriate contact(s).

The one or more user devices of the contact then receive responses from the contacts. For example, the contact receives a text message, phone call, video call, etc. in relation to the message from the user device of the patient, and

Block 2407: The user device receives response(s) from appropriate contact(s).

Block 2408: The user device generates appropriate response based on received response(s) from appropriate contact(s).

Block 2409: The user device identifies the appropriate voice library for outputting the appropriate response.

Block 2410: The user device outputs audio or visual (or both) data using the appropriate response and identified voice library.

In this way, the response from the one or more contacts are relayed back to the user device of the user.

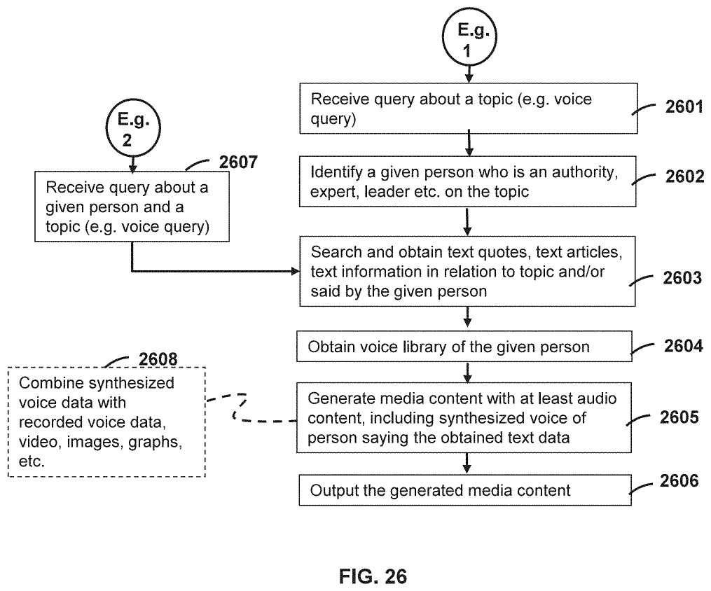

Turning to FIG. 26, example executable instructions are provided for outputting media content that includes synthesized voice content.

For example, a user asks “Tell me about Tesla's car production”. The data enablement application identifies that Elon Musk is a related authority on this topic, finds the related content (e.g. text content, audio, video, etc.), and uses Elon Musk's synthesized voice to explain Tesla's car production. For example, a chat bot using Elon Musk's synthesized voice says “Hello, I'm Elon Musk. Tesla's car manufacturing plants are located in . . . ”.

In another example, a user says “Tell me about Bill Nye's thoughts on climate change”. The data enablement application does a search for content (e.g. text content, audio, video, etc.) of Bill Nye in relation to climate change, and uses Bill Nye's synthesized voice to explain his views climate change and global warming. For example, a chat bot using Bill Nye's synthesized voice says “Hello, I'm Bill Nye the science guy. Climate change is based on science . . . ”.

In a first example embodiment in FIG. 26, the process starts with block 2601.

Block 2601: Receive query about a topic (e.g. voice query)

Block 2602: Identify a given person who is an authority, expert, leader etc. on the topic

Block 2603: Search and obtain text quotes, text articles, text information in relation to topic and/or said by the given person

Block 2604: Obtain voice library of the given person

Block 2605: Generate media content with at least audio content, including synthesized voice of person saying the obtained text data

Block 2606: Output the generated media content

In a second example embodiment, the process starts at block 2607 and continues from block 2607 to block 2603, then block 2604 and so forth.

Block 2607: Receive query about a given person and a topic (e.g. voice query)

In an example aspect of block 2605, the data enablement platform combines the synthesized voice data with recorded voice data, video, images, graphs, etc. (block 2608). In other words, the generated media content includes multiple types of media.

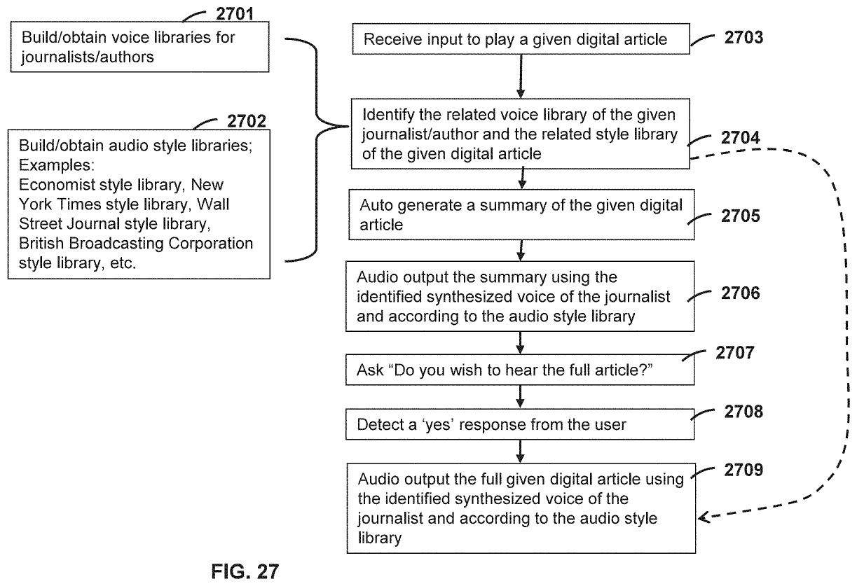

Turning to FIG. 27, an example embodiment is provided in which different journalists or authors have different voice libraries. In this way, when a user interacts or listens to a digital article, they can listen to the synthesized voice of the journalist or the author of the digital article.

In an example embodiment, different audio style libraries are associated with different digital magazine publications. In particular, it is herein recognized that different publications have different writing styles. In the example embodiment in FIG. 27, different publications have different sets of audio style parameters that affect the voice attributes of the voices of the journalist or the authors. For example, the journalists working at the Economist have their synthesized voices further modified according to the Economist's audio style library; and the journalists working at the New York Times have their synthesized voices further modified according to the New York Time's audio style library.

In an example embodiment, an audio style library includes one or more the following parameters: tone; frequency (e.g. also called timbre); loudness; rate at which a word or phrase is said (e.g. also called tempo); phonetic pronunciation; lexicon (e.g. choice of words); syntax (e.g. choice of sentence structure); articulation (e.g. clarity of pronounciation); rhythm (e.g. patterns of long and short syllables); melody (e.g. ups and downs in voice); phrases; questions; and amount of detail given in a question or a statement. In an example embodiment, the different audio style libraries store the parameters that define each publication's audio style.

In another example aspect using the process of FIG. 27, a first journalist and a second journalist at the New York Times can still sound different, but are further modified to produce some consistency in the way the synthesized voices speak, which is meant to be characteristic of the New York Times.

In FIG. 27, the data enablement platform builds or obtains various libraries, as per blocks 2701 and 2702.

At block 2701, the data enablement platform builds or obtains voice libraries for journalist and authors.

At block 2702, the data enablement platform builds or obtains audio style libraries. Non-limiting examples include an Economist style library, a New York Times style library, a Wall Street Journal style library, a British Broadcasting Corporation style library, etc.

After the libraries are obtained a response to a query can be processed.

Block 2703: the data enablement platform receives an input to play or hear a given digital article.

Block 2704: the data enablement platform identifies the related voice library of the given journalist/author and the related style library of the given digital article.

Block 2705: the data enablement platform automatically generates a summary of the given digital article.

Block 2706: the data enablement platform or the user device outputs, via audio, the summary using the identified synthesized voice of the journalist and according to the audio style library.

Block 2707: the data enablement platform or the user device asks “Do you wish to hear the full article?”

Block 2708: the data enablement platform or the user device detects the user responding ‘yes’.

Block 2709: the data enablement platform of the user device audio outputs the full given digital article using the identified synthesized voice of the journalist and according to the audio style library.

Additional general example embodiment and aspects are described below.

In an example embodiment, an oral computing device is provided, which includes a housing that holds at least: a memory device that stores thereon a data enablement application that includes multiple pairs of corresponding conversational bots and digital magazine modules, each pair specific to a user account and a topic; a display device to display a currently selected digital magazine; a microphone that is configured to record a user's spoken words as audio data; a processor configured to use the conversational bot to identify contextual data associated with the audio data, the contextual data including the currently selected digital magazine; a data communication device configured to transmit the audio data and the contextual data via a data network and, in response, receive response data, wherein the response data is text of an article about the topic; and an audio speaker that is controlled by the processor to read out the text of the article.

In an example aspect, the oral computing device is a wearable device to dynamically interact with the data. For example, the wearable device includes inertial measurement sensors. In another example, the wearable device is a smart watch. In another example, the wearable device is a headset. In another example, the wearable device projects images to provide augmented reality.

In another example aspect, the oral computing device projects light images on surrounding surfaces to provide augmented reality of virtual reality. In another example aspect, the oral computing device is in data connection with other devices that projects light images to provide augmented reality or virtual reality in a room. In effect, people that are physically present in the room, or virtual people being displayed by the projected light images, simultaneously interact and collaborate with each other.

In an example aspect, the oral computing device includes a graphics processing unit (GPU) that exchanges data with the processor, the GPU configured to pre-process the audio data using parallel threaded computations to extract data features, and the data communication device transmits the extracted data features in association with the contextual data and the audio data.

In an example embodiment, the oral computing device is a user device 102 or the specific embodiment of the OCD 301.

In another general example embodiment, a data enablement system (also herein called the data enablement platform) is provided that includes cloud computing servers that ingest audio data originating from one or more user devices, the audio data comprising at least oral conversation of one or more users, and the cloud computing servers configured to apply machine learning computations to extract at least content and sentiment data features.

There are also data science servers that are in data communication with the cloud computing servers and an external artificial intelligence computing platform. The data science servers include multiple user profiles, each user profile associated with multiple pairs of corresponding conversational bots and digital magazine modules, and each pair is specific to a given user account and a given topic. The data science servers also include a library of data science algorithms used to process, for a given conversational bot and a corresponding digital magazine module, the content and sentiment features. In other words, the data science algorithms may also be specific to a given pair of the given conversational bot and the corresponding digital magazine module. The data science servers output response data to the cloud computing servers, the response data being in response to the audio data. Subsequently, the cloud computing servers format the response data into an audio data format playable by a given user device, and transmit the formatted response data.

In another general example embodiment, an oral computing device comprises: a memory device that stores thereon at least a data enablement application that includes multiple pairs of corresponding conversational bots and digital magazine modules, each pair specific to a user account and a topic; a display device to display a currently selected digital magazine; a microphone that is configured to record a user's spoken words as audio data; a processor configured to use the conversational bot to identify contextual data associated with the audio data, the contextual data including the currently selected digital magazine; a data communication device configured to transmit the audio data and the contextual data via a data network and, in response, receive response data, wherein the response data is text of an article about the topic; and an audio speaker that is controlled by the processor to output an audio response derived from at least the text of the article.

In an example aspect, the memory device further stores thereon one or more synthesized voice libraries, wherein each of the one or more synthesized voice libraries comprise voice parameter features of one or more corresponding people, and the one or more synthesized voice libraries are used by the processor to generate the audio response.

In another example aspect, the memory device further stores thereon at least a synthesized voice library comprising voice parameter features of an author of the article; the processor is further configured to generate the audio response from the text of the article and the synthesized voice library; and the audio speaker outputs the text of the article in a synthesized voice of the author.

In another example aspect, the memory device further stores thereon at least a synthesized voice library comprising voice parameter features of a person interviewed or quoted in the article; the processor is further configured to generate the audio response from at least a portion of the text of the article and the synthesized voice library; and the audio speaker outputs at least the portion of the text of the article in a synthesized voice of the person that was interviewed or that was quoted.

In another example aspect, the memory device further stores thereon multiple synthesized voice libraries associated with the multiple digital magazine modules.

In another example aspect, the memory device further stores thereon multiple audio style libraries respectively associated with the multiple digital magazine modules, and each audio style library includes one or more parameters that are used by the conversational bot to affect the audio response; and the parameters comprise one or more of: tone; frequency; loudness; rate at which a word or phrase is said; phonetic pronunciation; lexicon; syntax; articulation; rhythm; and melody.

In another example aspect, the audio response comprises a summarization of the text of the article and a question asking the user if they wish to hear the full article.

In another example aspect, the oral computing device further receives a yes response to the question, and the oral computing device then generates another audio response that includes reading out, via the audio speaker, the text of the article in entirety.

In another example aspect, the response data further includes visual data that is outputted with the audio response using the display device.

In another example aspect, the display device comprises a display screen or a projector, or both.

In another example aspect, a portion of the text of the article is tagged, and the computing device the audio response includes playing the portion of the text with auditory emphasis.

In another example aspect, the auditory emphasis comprises playing the portion of the text by adjusting one or more of the following auditory parameters: speed of talking, loudness, and tone of voice.

In another example aspect, the portion of the text of the article is tagged if at least a certain number of other users have acted upon the portion of the text.

In another example aspect, the user account is associated with a feature data set of the user; and the oral computing device is further configured to download a new chat bot and a new digital magazine module of another user that has a similar feature data set to the user.

In another example aspect, the audio data includes voice data, which is analyzed for one or more data features including: text, meaning, emotion, culture, language, and health of the user; and the one or more data features are stored in association with the user account.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or computing devices or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

The GUIs and screen shots described herein are just for example. There may be variations to the graphical and interactive elements according to the principles described herein. For example, such elements can be positioned in different places, or added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. An oral computing device comprising:
a memory device that stores thereon at least a data enablement application that includes multiple pairs of corresponding conversational bots and digital magazine modules, each pair specific to a user account and a topic;
a display device to display a currently selected digital magazine;
a microphone that is configured to record a user's spoken words as audio data;
a processor configured to use the conversational bot to identify contextual data associated with the audio data, the contextual data including the currently selected digital magazine;
a data communication device configured to transmit the audio data and the contextual data via a data network and, in response, receive response data, wherein the response data is text of an article about the topic; and
an audio speaker that is controlled by the processor to output an audio response derived from at least the text of the article.

2. The oral computing device of claim 1 further comprising a graphics processing unit (GPU) that exchanges data with the processor, the GPU configured to pre-process the audio data using parallel threaded computations to extract data features, and the data communication device transmits the extracted data features in association with the contextual data and the audio data.

3. The oral computing device of claim 1 wherein the memory device further stores thereon one or more synthesized voice libraries, wherein each of the one or more synthesized voice libraries comprise voice parameter features of one or more corresponding people, and the one or more synthesized voice libraries are used by the processor to generate the audio response.

4. The oral computing device of claim 1 wherein the memory device further stores thereon at least a synthesized voice library comprising voice parameter features of an author of the article; the processor is further configured to generate the audio response from the text of the article and the synthesized voice library; and the audio speaker outputs the text of the article in a synthesized voice of the author.

5. The oral computing device of claim 1 wherein the memory device further stores thereon at least a synthesized voice library comprising voice parameter features of a person interviewed or quoted in the article; the processor is further configured to generate the audio response from at least a portion of the text of the article and the synthesized voice library; and the audio speaker outputs at least the portion of the text of the article in a synthesized voice of the person that was interviewed or that was quoted.

6. The oral computing device of claim 1 wherein the memory device further stores thereon multiple synthesized voice libraries associated with the multiple digital magazine modules.

7. The oral computing device of claim 1 wherein the memory device further stores thereon multiple audio style libraries respectively associated with the multiple digital magazine modules, and each audio style library includes one or more parameters that are used by the conversational bot to affect the audio response; and the parameters comprise one or more of: tone; frequency; loudness; rate at which a word or phrase is said; phonetic pronunciation; lexicon; syntax; articulation; rhythm; and melody.

8. The oral computing device of claim 1 wherein the audio response comprises a summarization of the text of the article and a question asking the user if they wish to hear the full article.

9. The oral computing device of claim 8 further receiving a yes response to the question, and the oral computing device then generating another audio response that includes reading out, via the audio speaker, the text of the article in entirety.

10. The oral computing device of claim 1 wherein the response data further includes visual data that is outputted with the audio response using the display device.

11. The oral computing device of claim 10 wherein the display device comprises a display screen or a projector, or both.

12. The oral computing device of claim 1 wherein a portion of the text of the article is tagged, and the computing device the audio response includes playing the portion of the text with auditory emphasis.

13. The oral computing device of claim 12 wherein the auditory emphasis comprises playing the portion of the text by adjusting one or more of the following auditory parameters: speed of talking, loudness, and tone of voice.

14. The oral computing device of claim 12 wherein the portion of the text of the article is tagged if at least a certain number of other users have acted upon the portion of the text.

15. The oral computing device of claim 1 wherein the user account is associated with a feature data set of the user; and the oral computing device is further configured to download a new chat bot and a new digital magazine module of another user that has a similar feature data set to the user.

16. The oral computing device of claim 1 wherein the audio data includes voice data, which is analyzed for one or more data features including: text, meaning, emotion, culture, language, and health of the user; and the one or more data features are stored in association with the user account.

17. A data enablement system comprising:
cloud computing servers that ingest audio data originating from one or more user devices, the audio data comprising at least oral conversation of one or more users, and the cloud computing servers configured to apply machine learning computations to extract at least content and sentiment data features;
data science servers in data communication with the cloud computing servers and an external artificial intelligence computing platform;
the data science servers comprising multiple user profiles, each user profile associated with multiple pairs of corresponding conversational bots and digital magazine modules, and each pair specific to a given user account and a given topic;
the data science servers comprising a library of data science algorithms used to process, for a given conversational bot and a corresponding digital magazine module, the content and sentiment features; and
the data science servers output response data to the cloud computing servers, the response data being in response to the audio data; and
the cloud computing servers formatting the response data into an audio data format playable by a given user device, and transmitting the formatted response data.
